(19) United States
(12) Patent Application Publication
(10) Pub. No.: US 2026/0286141 A1
(43) Pub. Date: Sep. 24, 2026

(54) POWDER COATING FORMULATIONS FOR HEAT SENSITIVE SUBSTRATES AND METHODS THEREOF

(71) Applicant: IFS Coatings, Inc., Gainesville, TX (US)

(72) Inventors: Rajendra Polu, Gainesville, TX (US); Glynn Mason, Gainesville, TX (US); Yotzin Mason, Gainesville, TX (US)

(21) Appl. No.: 19/183,205

(22) Filed: Apr. 18, 2025

Related U.S. Application Data
(60) Provisional application No. 63/636,669, filed on Apr. 19, 2024.
(60) Provisional application No. 63/762,552, filed on Feb. 24, 2025.

(51) Int. Cl. C09D 5/03; C09D 7/40; C09D 7/42; C09D 7/61; C09D 7/65; C09D 15/00; C09D 167/00

(52) U.S. Cl. CPC C09D 5/035; C09D 7/42; C09D 7/61; C09D 7/65; C09D 7/70; C09D 15/00; C09D 167/00

(57) ABSTRACT

Provided herein are powder formulations for a heat sensitive substrate, and methods of applying the powder formulations to at least a portion of a surface of a substrate. The powder formulations can include an acid functional polyester resin, a curing agent, a degassing agent, one or more spherical fillers, a phase-transfer catalyst, a flow modifier, a transfer efficiency additive, an antistatic agent, and other optional components. The methods can include pre-heating a substrate to a first temperature, applying a powder formulation to the substrate, and then heating the substrate with the coating applied to a second temperature.

### CROSS-REFERENCE TO RELATED APPLICATIONS

This application claims the benefit of U.S. Provisional Application No. 63/636,669, filed Apr. 19, 2024, and U.S. Provisional Application No. 63/762,552, filed Feb. 24, 2025, the contents of which are incorporated herein by reference in their entireties.

### TECHNICAL FIELD

This disclosure relates to powder coatings formulations for heat sensitive substrates such as oriented strand board and others.

### BACKGROUND

Powder coatings are superior to traditional liquid coatings in terms of sustainability because powder coatings are free of toxic solvents. Powder coatings, however, can be prone to poor coverage of certain surfaces, including those that are heat-sensitive, such as oriented strand board (OSB), fiber-cement siding, engineered cement board, fiber glass, medium-density fiberboard (MDF), high-density fiberboard (HDF), and particle board.

The timbers used in OSB generally include softwood and hard wood. Wood strands are cut tangentially for about 8-15 cm long from the debarked logs. After drying, these flakes are generally sprayed with synthetic resin and wax and then bonded under and pressure between steel belts. The process of producing OSB is prone to trapping air within the layers. OSB is primarily intended to be a functional board, which can be coated with water based, solvent based, solvent free, or oil based paints. These boards are designed to hold up a limited amount of rain and weather exposure, however OSB manufacturers do not recommend long term exposure of OSB to the outdoors as they prone to rotting, warping, swelling, chipping, and paint loss. In certain situations, OSB boards require a weatherable, flexible coatings that will last longer and will exhibit good adhesion strength, wherein swelling, warping, chipping, and rotting can be minimized. Also, soft wood used in the OSB tend to undergo out-gassing during the curing of the coatings. OSB has a thin layer wax coating that protects it against moisture and inhibits painting. Due to OSB strands being prominent, they are usually visible through one coat of painting, therefore multiple coats of primer are required to remove some of the texture of the wood and to close any pores. The edges of boards cannot be exposed to water otherwise the OSB may swell and crack. Coatings should be flexible enough to expand and contract along the expansion cycles of the OSB. During the warm summer months, heat and humidity may cause the wood items to absorb moisture and swell.

### SUMMARY

The present document relates to powder coatings that can be formulated to provide improved weatherable, flexible, and defect free powder coatings for the longevity of OSB and other heat sensitive substrates.

Accordingly, aspects of the present disclosure provide a powder formulation for a heat sensitive substrate, the formulation comprising: an acid functional polyester resin; a curing agent; a catalyst; a transfer efficiency additive; an antistatic agent; and one or both of a spherical filler and a gloss reducer. In some embodiments, the formulation further comprises a degassing agent, a flow modifier, or a combination thereof.

In some embodiments, the powder formulation comprises an acid functional polyester resin; a curing agent; a degassing agent; a catalyst; a flow modifier; a transfer efficiency additive; an antistatic agent; and one or more of the following: a spherical filler, an amorphous metal silicate, a crystalline resin, a thermoplastic additive, an adhesion promoter, a co-crosslinker, and a gloss reducer. In some embodiments, the formulation further comprises one or more of a viscosity modifier and an antimicrobial agent.

In some embodiments, the powder formulation comprises an acid functional polyester resin; a curing agent; a degassing agent; one or more spherical fillers; a phase-transfer catalyst; a flow modifier; a transfer efficiency additive; an antistatic agent; and optionally one or more of the following: a crystalline resin, a thermoplastic additive, an adhesion promoter, a co-crosslinker, a gloss reducer, a viscosity modifier, and an antimicrobial agent.

In some embodiments, the formulation has one or more of the following characteristics: improved flexibility under humid conditions; improved inter-coat adhesion; improved water permeability; improved exterior weathering; improved uniform integrity; improved outgassing during cure; and/or improved heat distribution.

In some embodiments, the disclosure provides powder formulation for a heat sensitive substrate comprising: about 30 wt % to about 90 wt % of an acid functional polyester resin; about 3 wt % to about 10 wt % of a curing agent; about 0.1 wt % to about 5 wt % of a degassing agent; about 0.1 wt % to about 6 wt % of a catalyst; about 0.1 wt % to about 5 wt % of a flow modifier; about 0.1 wt % to about 5 wt % of a transfer efficiency additive; and about 0.1 wt % to about 2 wt % of an antistatic agent.

In some embodiments, the disclosure provides powder formulation for a heat sensitive substrate comprising: about 40 wt % to about 65 wt % of an acid functional polyester resin (e.g., SP-6491); about 4 wt % to about 10 wt % of a curing agent (e.g., triglycidyl isocyanurate (TGIC)); about 0.05 wt % to about 5 wt % of a degassing agent (e.g., benzoin); about 1 wt % to about 20 wt % of one or more spherical fillers (e.g., Spheriglass 3000E and/or Spherilex DP-015); about 0.1 wt % to about 5 wt % of a phase-transfer catalyst (e.g., tetraalkyl ammonium halide); about 0.1 wt % to about 5 wt % of a flow modifier (e.g., an acrylic polymer); about 0.1 wt % to about 5 wt % of a transfer efficiency additive (e.g., barium titanate); and about 0.1 wt % to about 2 wt % of an antistatic agent (e.g., a hydroxyalkylamide).

The disclosure also provides a method of applying a powder formulation to a heat sensitive substrate comprising: pre-heating the heat sensitive substrate to a first temperature; applying a powder formulation (e.g., any described herein) to the heat sensitive substrate to form a coat on at least a portion of a surface of the heat sensitive substrate; and heating the heat sensitive substrate with the coat applied thereon to a second temperature. In some embodiments, the method forms a cured coating on at least a portion of the surface of the heat sensitive substrate.

### BRIEF DESCRIPTION OF THE DRAWINGS

FIG. 1 is a representative image of visible defects in a coating.

FIG. 2 is a representative image of Hinge Hole Tests performed on coated substrates.

FIG. 3 is a representative image of pill flow measurements for example powder formulations.

### DETAILED DESCRIPTION

The present disclosure relates to powder formulations for a substrate. In some embodiments, the substrate is a heat sensitive substrate. In turn, the powder formulation can be used to form a coating on the substrate. Methods of making and using such formulations are also provided herein.

### Formulations

In some embodiments, the present disclosure provides a powder formulation for a heat sensitive substrate, the formulation comprising: an acid functional polyester resin; a curing agent; a catalyst; a transfer efficiency additive; an antistatic agent; and one or both of the following: a spherical filler and a gloss reducer. In some embodiments, the formulation further comprises a degassing agent. In some embodiments, the formulation further comprises a flow modifier. In some embodiments, the formulation comprises the degassing agent and the flow modifier. In some embodiments, the powder formulation further comprises one or more of the following: an amorphous metal silicate, a crystalline resin, a thermoplastic additive, an adhesion promoter, and a co-crosslinker.

In some embodiments, the powder formulation comprises: about 30 wt % to about 90 wt % of an acid functional polyester resin;
about 3 wt % to about 10 wt % of a curing agent;
about 0.1 wt % to about 6 wt % of a catalyst;
about 0.1 wt % to about 5 wt % of a transfer efficiency additive;
about 0.1 wt % to about 5 wt % of an antistatic agent; and
one or more of the following: about 1 wt % to about 30 wt % of a spherical filler, and about 0.1 wt. % to about 40 wt. % of a gloss reducer.

In some embodiments, the powder formulation comprises:
about 30 wt % to about 90 wt % of an acid functional polyester resin;
about 3 wt % to about 10 wt % of a curing agent;
about 0.1 wt % to about 6 wt % of a catalyst;
about 0.1 wt % to about 5 wt % of a transfer efficiency additive;
about 0.1 wt % to about 5 wt % of an antistatic agent; and
about 1 wt % to about 30 wt % of a spherical filler.

In some embodiments, the powder formulation comprises:
about 30 wt % to about 90 wt % of an acid functional polyester resin;
about 3 wt % to about 10 wt % of a curing agent;
about 0.1 wt % to about 6 wt % of a catalyst;
about 0.1 wt % to about 5 wt % of a transfer efficiency additive;
about 0.1 wt % to about 5 wt % of an antistatic agent; and
about 0.1 wt. % to about 40 wt. % of a gloss reducer.

In some embodiments, the present disclosure provides a powder formulation for a heat sensitive substrate, the formulation comprising: an acid functional polyester resin; a curing agent; a degassing agent; a catalyst; a flow modifier; a transfer efficiency additive; an antistatic agent; and one or more of the following: a spherical filler, an amorphous metal silicate, a crystalline resin, a thermoplastic additive, an adhesion promoter, a co-crosslinker, and a gloss reducer. In some embodiments, the powder formulation further comprises one or both of a viscosity modifier and an antimicrobial agent. In some embodiments, the powder formulation further comprises a texture additive.

In some embodiments, the powder formulation comprises:
about 30 wt % to about 90 wt % of an acid functional polyester resin;
about 3 wt % to about 10 wt % of a curing agent;
about 0.1 wt % to about 5 wt % of a degassing agent;
about 0.1 wt % to about 6 wt % of a catalyst;
about 0.1 wt % to about 5 wt % of a flow modifier;
about 0.1 wt % to about 5 wt % of a transfer efficiency additive;
about 0.1 wt % to about 5 wt % of an antistatic agent; and
one or more of the following: about 1 wt % to about 20 wt % of a spherical filler, about 1 wt % to about 30 wt % of an amorphous metal silicate, about 1 wt % to about 30 wt % of a crystalline resin, about 0.1 wt % to about 5 wt % of a thermoplastic additive, about 1 wt % to about 30 wt % of an adhesion promoter, about 0.1 wt % to about 5 wt % of a co-crosslinker, and about 0.1 wt % to about 40 wt % of a gloss reducer. In some embodiments, the formulation further comprises one or both of a viscosity modifier and an antimicrobial agent.

In some embodiments, the powder formulation comprises:
about 30 wt % to about 90 wt % of an acid functional polyester resin;
about 3 wt % to about 10 wt % of a curing agent;
about 0.1 wt % to about 5 wt % of a degassing agent;
about 0.1 wt % to about 6 wt % of a catalyst;
about 0.1 wt % to about 5 wt % of a flow modifier;
about 0.1 wt % to about 5 wt % of a transfer efficiency additive;
about 0.1 wt % to about 5 wt % of an antistatic agent;
about 1 wt % to about 30 wt % of a crystalline resin; and
about 0.1 wt % to about 5 wt % of a thermoplastic additive. In some embodiments, the powder formulation further comprises one or more of the following: about 1 wt % to about 20 wt % of a spherical filler, about 1 wt % to about 30 wt % of an amorphous metal silicate, and about 0.1 wt % to about 5 wt % of an antimicrobial agent.

In some embodiments, the powder formulation comprises:
about 30 wt % to about 90 wt % of an acid functional polyester resin;
about 3 wt % to about 10 wt % of a curing agent;
about 0.1 wt % to about 5 wt % of a degassing agent;
about 0.1 wt % to about 6 wt % of a catalyst;
about 0.1 wt % to about 5 wt % of a flow modifier;
about 0.1 wt % to about 5 wt % of a transfer efficiency additive;
about 0.1 wt % to about 5 wt % of an antistatic agent; and
about 0.1 wt % to about 5 wt % of a thermoplastic additive. In some embodiments, the powder formulation further comprises one or both of the following: about 1 wt % to about 20 wt % of a spherical filler, and about 1 wt % to about 30 wt % of an amorphous metal silicate.

In some embodiments, the powder formulation comprises:
about 30 wt % to about 90 wt % of an acid functional polyester resin;
about 3 wt % to about 10 wt % of a curing agent;
about 0.1 wt % to about 5 wt % of a degassing agent;
about 0.1 wt % to about 6 wt % of a catalyst;
about 0.1 wt % to about 5 wt % of a flow modifier;
about 0.1 wt % to about 5 wt % of a transfer efficiency additive;
about 0.1 wt % to about 5 wt % of an antistatic agent; and
one or more of the following: about 1 wt % to about 20 wt % of a spherical filler, about 1 wt % to about 30 wt % of an amorphous metal silicate, about 0.1 wt % to about 5 wt % of a thermoplastic additive, about 1 wt % to about 30 wt % of an adhesion promoter, and about 0.1 wt % to about 40 wt % of a gloss reducer.

In some embodiments, the powder formulation comprises:
about 30 wt % to about 90 wt % of an acid functional polyester resin;
about 3 wt % to about 10 wt % of a curing agent;
about 0.1 wt % to about 5 wt % of a degassing agent;
about 0.1 wt % to about 6 wt % of a catalyst;
about 0.1 wt % to about 5 wt % of a flow modifier;
about 0.1 wt % to about 5 wt % of a transfer efficiency additive;
about 0.1 wt % to about 5 wt % of an antistatic agent;
about 1 wt % to about 20 wt % of a spherical filler; and
about 0.1 wt % to about 40 wt % of a gloss reducer. In some embodiments, the formulation further comprises about 0.1 wt % to about 5 wt % of a viscosity modifier.

In some embodiments, the powder formulation comprises:
about 30 wt % to about 90 wt % of an acid functional polyester resin;
about 3 wt % to about 10 wt % of a curing agent;
about 0.1 wt % to about 5 wt % of a degassing agent;
about 0.1 wt % to about 6 wt % of a catalyst;
about 0.1 wt % to about 5 wt % of a flow modifier;
about 0.1 wt % to about 5 wt % of a transfer efficiency additive;
about 0.1 wt % to about 5 wt % of an antistatic agent; and about 0.1 wt % to about 40 wt % of a gloss reducer.

In some embodiments, the powder formulation comprises:
about 30 wt % to about 90 wt % of an acid functional polyester resin;
about 3 wt % to about 10 wt % of a curing agent;
about 0.1 wt % to about 6 wt % of a catalyst;
about 0.1 wt % to about 5 wt % of a transfer efficiency additive;
about 0.1 wt % to about 5 wt % of an antistatic agent; and
about 0.1 wt % to about 40 wt % of a gloss reducer.

In some embodiments, the present disclosure provides a powder formulation for a heat sensitive substrate, the formulation comprising: an acid functional polyester resin; a curing agent; a degassing agent; one or more spherical fillers; a phase-transfer catalyst; a flow modifier; a transfer efficiency additive; an antistatic agent; and optionally one or more of the following: a crystalline resin, a thermoplastic additive, an adhesion promoter, a co-crosslinker, a gloss reducer, a viscosity modifier, and an antimicrobial agent.

In some embodiments, the powder formulations described herein are formulated to provide a thermoset powder coating. In some embodiments, the formulation provides a thermoset powder coating that has one or more of the following characteristics: improved flexibility under humid conditions; improved inter-coat adhesion; improved water permeability; improved exterior weathering; improved uniform integrity; improved outgassing during cure; and/or improved heat distribution.

In some embodiments, the powder formulations described herein possess certain characteristics to address challenges that can be encountered when using conventional powder coatings. Without wishing to be limited by mechanism or theory, the use of powder formulations can be challenging with certain types of surfaces, such as those having non-planar features (e.g., edges, welds) and/or those having certain compositions disposed thereon (e.g., a sealant composition disposed on a portion of a surface) and/or those formed from certain materials (e.g., engineered wood or plastics, which can be sensitive to heat exposure). As described herein, certain types and/or amounts of components can be provided to enhance one or more characteristics of the powder formulation or a coating formed by using such a formulation.

In some embodiments, a powder formulation and/or a coating (e.g., formed from one or more powder formulations) is characterized, but are not limited to one or more of the following:
(a) Conventional powder coatings can be prone to poor flexibility under humid conditions. Without wishing to be bound by theory, a powder formulation can be configured to allow for improved flexibility under humid conditions to allow the substrate to expand and contract in humid conditions. In some embodiments, the powder formulation can include one or more components of a type and/or in an amount configured to provide improved flexibility. Thus, in some non-limiting embodiments, a powder formulation herein can provide improved flexibility in humid conditions, as compared to a conventional powder coating.
(b) Conventional powder coatings can be prone to poor inter-coat adhesion when an additional coating is applied. The coatings of the present disclosure show excellent inter-coat adhesion with a protective wax layer; hence it can be applied on non-sanded or sanded surfaces of a substrate such as OSB.
(c) Conventional powder coatings can often be prone to moisture accumulation, swelling, warping, mold development, and/or degradation. Without wishing to be bound by theory, a formulation of the present disclosure allows the water vapors to travel in and out of the coatings so that the moisture can freely escape from one to an another.
(d) Conventional powder coatings can be characterized as having poor exterior weatherability and are not suitable for exterior applications particularly for residential and commercial building's siding. In contrast, formulations of the present disclosure show good exterior weathering.
(e) Conventional powder coatings can be prone to discoloring or having poor uniformity, which can result when a substance from the substrate bleeds through the coating, thereby creating a discolored finish. Without wishing to be bound by theory, a powder formulation can be configured to minimize the bleed through of substances from the substrate through the powder formulation or powder coating to provide a uniform finish. In some embodiments, the powder formulation can include one or flow modifiers or other components of a type and/or in an amount configured to provide reduced bleed through and/or reduced discoloring. Thus, in some non-limiting embodiments, a powder formulation herein can provide reduced bleed through or discoloring, as compared to a conventional powder coating.
(f) Conventional powder coatings can be prone to gassing defects arising from trapped gas (e.g., volatile gas, moisture, air) that evolve through the coating during curing, which in turn may cause holes or other discontinuous features to form in the coating. Without wishing to be bound by theory, a powder formulation can be configured to allow for degassing of trapped gas from the wood composites, such as MDF, through the powder formulation during curing, thereby preventing formation of a continuous coating. In some embodiments, the powder formulation can include one or degassing agents, flow modifiers, or other components of a type and/or in an amount configured to provide reduced degassing defects. Thus, in some non-limiting embodiments, a powder formulation herein can provide reduced gassing defects, as compared to a conventional powder coating. In other non-limiting embodiments, the powder formulation herein can provide a coating having minimal presence of pinholes, which are pore-like penetrations in the coating due to entrapment of gas.
(g) The formulations of the present disclosure use mixed metal oxide pigments (also called as inorganic pigments) that reflect the sun's radiation and significantly reduce the amount of heat buildup, thereby minimizing the humidity levels. As the temperature cool, the humidity lowers, and the wood releases the buildup moisture and shrinks to the original size. Thus, in some non-limiting embodiments, a powder formulation herein can provide improved heat distribution as compared to a conventional powder coating.
(h) Conventional powder coatings can often be prone to poor substrate wetting. Without wishing to be bound by theory, a powder formulation can be configured to exhibit improved flow properties that allow more robust substrate wetting than can be achieved using conventional powder coatings. In some embodiments, the powder formulation can include one or more flow modifiers, phase-transfer catalysts, transfer efficiency additives, or other components of a type and/or in an amount configured to provide improved substrate wetting. Thus, in some non-limiting embodiments, a powder formulation herein can provide improved substrate wetting as compared to a conventional powder coating.
(i) Conventional powder coatings can often be heated at high temperatures to ensure formation of a cured coating. Without wishing to be bound by theory, a powder formulation can be configured to exhibit lower cure temperatures, thereby reducing substrate distortion and energy demands compared to conventional powder coatings. In some embodiments, the powder formulation can include one or more flow modifiers, phase-transfer catalysts, transfer efficiency additives, or other components of a type and/or in an amount configured to provide lower cure temperatures compared to conventional powder coating. Thus, in some non-limiting embodiments, a powder formulation herein can provide lower cure temperatures as compared to a conventional powder coating.

In some embodiments, the heat sensitive substrate comprises a non-metal substrate. In some embodiments, the heat sensitive substrate comprises an oriented strand board, fiber-cement siding, engineered cement board, wood, fiberglass board, particle board, medium-density fiberboard, or high-density fiberboard.

### Polyester Resin

In some embodiments, the acid functional polyester resin is an isophthalic acid based polyester resin, a terephthalic acid based polyester resin, or a polyester resin with carboxylic acid groups.

In some embodiments, the powder formulation comprises about 30 wt % to about 99 wt % of the acid functional polyester resin. In some embodiments, the powder formulation comprises about 30 wt % to about 90 wt % of the acid functional polyester resin. In some embodiments, the powder formulation comprises an acid functional polyester resin in any amount such that the total amount of resin in the formulation is about 35 wt. % to about 97 wt. %, or about 35 wt % to about 65 wt %. In some embodiments, the acid functional polyester resin is present in a total amount of about 45 wt % to about 90 wt % of the formulation. In some embodiments, the acid functional polyester resin is present in a total amount of about 45 wt % to about 87 wt % of the formulation.

In some embodiments, the powder formulation comprises an acid functional polyester resin in any amount such that the total amount of resin in the formulation is about 40 wt % to about 65 wt %. For example, the total amount of resin in the formulation is about 40-65 wt %, for example about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt %. In some embodiments, the total amount of resin in the formulation is about 45-65 wt %, 50-65 wt %, 55-65 wt %, 60-65 wt %, 40-60 wt %, 45-60 wt %, 55-60 wt %, 40-55 wt %, 40-60 wt %, 40-65 wt %, 45-55 wt %, 50-55 wt %, 40-50 wt %, or 45-50 wt %. In some embodiments, the total amount of resin in the formulation is about 42-62 wt %, 42-60 wt %, 42-58 wt %, 42-56 wt %, 42-54 wt %, 42-52 wt %, 42-50 wt %, 42-48 wt %, 42-46 wt %, 42-44 wt %, 42-62 wt %, 42-60 wt %, 42-58 wt %, 42-56 wt %, 42-54 wt %, 42-52 wt %, 42-50 wt %, 42-48 wt %, 42-46 wt %, 42-44 wt %, 44-62 wt %, 44-60 wt %, 44-58 wt %, 44-56 wt %, 44-54 wt %, 44-52 wt %, 44-50 wt %, 44-48 wt %, 44-46 wt %, 44-44 wt %, 44-62 wt %, 44-60 wt %, 44-58 wt %, 44-56 wt %, 44-54 wt %, 44-52 wt %, 44-50 wt %, 44-48 wt %, 44-46 wt %, 46-62 wt %, 46-60 wt %, 46-58 wt %, 46-56 wt %, 46-54 wt %, 46-52 wt %, 46-50 wt %, 46-48 wt %, 46-46 wt %, 46-44 wt %, 46-62 wt %, 46-60 wt %, 46-58 wt %, 46-56 wt %, 46-54 wt %, 46-52 wt %, 46-50 wt %, 46-48 wt %, 48-62 wt %, 48-60 wt %, 48-58 wt %, 48-56 wt %, 48-54 wt %, 48-52 wt %, 48-50 wt %, 48-48 wt %, 48-46 wt %, 48-44 wt %, 48-62 wt %, 48-60 wt %, 48-58 wt %, 48-56 wt %, 48-54 wt %, 48-52 wt %, 48-50 wt %, 50-60 wt %, 50-58 wt %, 50-56 wt %, 50-54 wt %, 50-52 wt %, 50-48 wt %, 50-46 wt %, 50-44 wt %, 50-62 wt %, 50-60 wt %, 50-58 wt %, 50-56 wt %, 50-54 wt %, 50-52 wt %, 52-62 wt %, 52-60 wt %, 52-58 wt %, 52-56 wt %, 52-54 wt %, 52-52 wt %, 52-52 wt %, 52-48 wt %, 52-46 wt %, 52-44 wt %, 52-62 wt %, 52-60 wt %, 52-58 wt %, 52-56 wt %, 52-54 wt %, 54-62 wt %, 54-60 wt %, 54-58 wt %, 54-56 wt %, 54-54 wt %, 54-52 wt %, 54-54 wt %, 54-48 wt %, 54-46 wt %, 54-44 wt %, 54-62 wt %, 54-60 wt %, 54-58 wt %, 54-56 wt %, 56-62 wt %, 56-60 wt %, 56-58 wt %, 56-56 wt %, 56-54 wt %, 56-52 wt %, 56-56 wt %, 56-48 wt %, 56-46 wt %, 56-44 wt %, 56-62 wt %, 56-60 wt %, 56-58 wt %, 58-62 wt %, 58-60 wt %, 58-58 wt %, 58-56 wt %, 58-54 wt %, 58-52 wt %, 58-58 wt %, 58-48 wt %, 58-46 wt %, 58-44 wt %, 58-62 wt %, or 58-60 wt %.

In some embodiments, the powder formulation comprises the acid functional polyester resin in a total amount of about 40 wt. % to about 97 wt. %, about 45 wt. % to about 97 wt. %, about 30 wt. % to about 90 wt. %, about 40 wt. % to about 90 wt. %, about 40 wt. % to about 87 wt. %, about 40 wt. % to about 87 wt. %, about 50 wt % to about 55 wt %, or about 35 wt % to about 40 wt %. In some embodiments, the acid functional polyester resin is present in a total amount of about 60 wt % to about 62 wt % of the formulation. In some embodiments, the acid functional polyester resin is present in a total amount of about 63 wt % of the formulation. In some embodiments, the acid functional polyester resin is present in a total amount of about 64 wt % of the formulation. In some embodiments, the acid functional polyester resin is present in a total amount of about 60 wt % of the formulation.

In some embodiments, the powder formulation comprises the acid functional polyester resin in a total amount of at least about 30 wt %, (e.g., at least about 35 wt %, at least about 40 wt %, at least about 45 wt %, at least about 50 wt %, at least about 55 wt %, at least about 60 wt %, at least about 65 wt %, or at least about 70 wt %) and/or at most about 90 wt % (e.g., at most about 85 wt %, at most about 80 wt %, at most about 75 wt %, at most about 70 wt %, at most about 65 wt %, or at most about 60 wt %) of the formulation.

In some embodiments, the acid functional polyester resin is a polyester resin with an acid value of 30-70, e.g., about 30 to about 65, about 30 to about 60, about 30 to about 50, about 30 to about 45, about 30 to about 40, about 30 to about 35, about 35 to about 65 mg, about 35 to about 60, about 35 to about 55, about 35 to about 50, about 35 to about 45, about 40 to about 65, about 40 to about 60, about 40 to about 55, about 40 to about 50, about 45 to about 60, about 45 to about 55, about 45 to about 50, about 50 to about 65, about 50 to about 60, or about 50 to about 55. In some embodiments, the acid value is provided as mg KOH/g of resin. In some embodiments, the resin is characterized by a viscosity of about 1,000 to 10,000 mPa·s at 200° C., e.g., about 2,500 to 10,000; about 5,000 to 10,000; about 7,500 to 10,000; about 1,000 to 7,500; about 1,000 to 5,000; or about 1,000 to 2,500 mPa·s at 200° C. In some embodiments, viscosity is determined in accordance with ASTM test method D4287.

Non-limiting examples for acid functional polyester resins include SP resins from Sun Polymers International Inc., Mooresville, IN (e.g., such as SP-6491, an acid functional polyester resin having an acid value of 25-70, a Tg of about 70° C., and a viscosity of 1,800-2,800 mPa·s at 200° C.; or SP-7400, an acid functional polyester resin having an acid value of 30-35, a Tg of about 64° C., and a viscosity of 1,000-1,900 mPa·s at 200° C.); Crylcoat® resins from Allnex, Frankfurt, Germany (e.g., Crylcoat® 4420-0, a carboxyl functional polyester resin having an acid value from 49-54, a Tg of about 64° C., and a viscosity of 4,500-6,600 mPa·s at 200° C.; or Crylcoat® 4626-0, a carboxyl functional polyester resin having an acid value from 47-53, a Tg of about 64° C., and a viscosity of 3,800-5,200 mPa·s at 200° C.); Rucote® resins from Stepan Company, Northfield, IL (e.g., Rucote® 9010, a carboxyl functional polyester resin having an acid value of 32, a Tg of about 66° C., and a viscosity of 4,000-4,500 mPa·s at 200° C.); or Uralac® resins from Covestro AG, Leverkusen, Germany (e.g., Uralac® P 3281, a saturated, carboxylated polyester resin having an acid value from 34-38, a Tg of about 57° C., and a viscosity of 5,000-35,000 mPa·s at 160° C.; Uralac® P 3280, a carboxylated polyester resin having an acid value from 34-37, a Tg of about 57° C., and a viscosity of 5,000-35,000 mPa·s at 160° C.; or Uralac® P 9000, a carboxylated polyester resin having an acid value from 46-50 and a viscosity of 100-2,000 mPa·s at 160° C.). Combinations of such acid functional polyester resins, or any other resins herein, may be employed.

### Curing Agent

In some embodiments, the powder formulation comprises a curing agent. In some embodiments, the curing agent comprises a polyepoxide, an isocyanate, a glycidyl ester, a hydroxyalkylamide, or a combination of any of these.

In some embodiments, the curing agent comprises triglycidyl isocyanurate (TGIC), tris(2,3-epoxypropyl) isocyanurate, glycidyl methacrylate, triglycidyl trimellitate, diglycidyl terephthalate, β-hydroxyalkylamide, or a combination of any of these. In some embodiments, the curing agent comprises a polyepoxide, an isocyanate, a glycidyl ester, a hydroxyalkylamide, or a combination of any of these. In some embodiments, the polyepoxide is a functional epoxy resin. In some embodiments, the functional groups on the epoxy resin react with the acid functional polyester resin.

In some embodiments, the powder formulation comprises about 3 wt % to about 15 wt % of a curing agent. In some embodiments, the powder formulation comprises about 3 wt % to about 10 wt % of a curing agent. In some embodiments, the curing agent comprises triglycidyl isocyanurate, tris(2,3-epoxypropyl) isocyanurate, glycidyl methacrylate, triglycidyl trimellitate, diglycidyl terephthalate, β-hydroxyalkylamide, or a combination of any of these in a total amount of about 4 wt % to about 10 wt % of the formulation, e.g., about 4 wt % to about 9 wt %, about 4 wt % to about 8 wt %, about 4 wt % to about 7 wt %, about 4 wt % to about 6 wt %, about 4 wt % to about 5 wt %, about 5 wt % to about 10 wt, about 5 wt % to about 9 wt %, about 5 wt % to about 8 wt %, about 5 wt % to about 7 wt %, about 5 wt % to about 6 wt %, about 6 wt % to about 10 wt, about 6 wt % to about 9 wt %, about 6 wt % to about 8 wt %, about 6 wt % to about 7 wt %, about 7 wt % to about 10 wt %, about 7 wt % to about 9 wt %, about 7 wt % to about 8 wt, about 8 wt % to about 10 wt %, or about 8 wt % to about 9 wt % of the formulation. In some embodiments, the powder formulation comprises a curing agent in a total amount of about 3 wt. % to about 10 wt. %, about 3 wt. % to about 6 wt. %, or about 5 wt. % to about 10 wt. % of the formulation. In some embodiments, the curing agent is present in a total amount of about 5 wt % to about 11 wt % of the formulation. In some embodiments, the curing agent is present in a total amount of about 5 wt % to about 7 wt % of the formulation. In some embodiments, the curing agent is present in a total amount of about 5 wt % to about 9.7 wt % of the formulation.

In some embodiments, the powder formulation comprises one or more curing agents (e.g., any described herein) in a total amount of at least about 3 wt % (e.g., at least about 3.5 wt %, at least about 4 wt %, at least about 4.5 wt %, or at least about 5 wt %) and/or at most about 10 wt % (e.g., at most about 8 wt %, at most about 7.5 wt %, at most about 7 wt %, at most about 6.5 wt %, at most about 6 wt %, at most about 5.5 wt %, or at most about 5 wt %) of the formulation.

In some embodiments, the polyepoxide comprises a plurality of —CH(O)CH₂ groups or a plurality of —CH₂CH(O)CH₂ groups. In some embodiments, the isocyanate comprises one or more —NCO groups. In some embodiments, the glycidyl ester includes one or more of —C(O)OCH₂CH(O)CH₂ groups.

In some embodiments, the hydroxyalkylamide is (R¹)₂NC(O)-Ak-C(O)N(R¹)₂, in which each R¹ is, independently, hydrogen (H) or an optionally substituted C1-18 hydrocarbyl group (e.g., alkyl, haloalkyl, hydroxyalkyl, aryl, alkaryl, aralkyl); Ak is an optionally substituted multivalent (e.g., divalent) substituted C1-18 hydrocarbyl group (e.g., alkylene, alkenylene, alkynylene); and at least one R¹ is an optionally substituted hydroxyalkyl.

In some embodiments, Ak is optionally substituted with one or more substituents described herein for hydrocarbyl or alkyl.

In some embodiments, at least one R¹ is an optionally substituted hydroxyalkyl, where the hydroxyalkyl is an alkyl group (e.g., as described herein) with one, two, three, or more hydroxyl groups (e.g., —OH). In some embodiments, the hydroxyalkyl is optionally substituted with one or more substituents described herein for hydrocarbyl or alkyl. In some embodiments, the hydroxyalkyl is-Ak-OH, in which Ak is alkylene optionally substituted with one or more substituents described herein for hydrocarbyl or alkyl.

In some embodiments, the curing agent comprises triglycidyl isocyanurate.

Depending on the resin present in the formulation, a corresponding curing agent can be selected based on its reactivity with the functional groups present on the resin. In addition to the type of curing agent, the amount of curing agent and resin can be selected to provide a coating having desired properties. In some embodiments, an optimized ratio of curing agent to resin depends on the number and type of reactive groups present on the resin and provided by the curing agent. In some embodiments, an equivalent ratio of curing agent and resin are included in the powder formulation to minimize the amount of unreacted resin and/or unreacted curing agent in the powder formulation. Accordingly, in some embodiments, the powder formulation comprises a curing agent and a resin in a ratio of about 1:1 in terms of the reactive group of the curing agent and the functional group of the resin that is capable of reacting with the reactive group of the curing agent.

In some embodiments, certain curing agents are suitable for use with certain resins. For example, a polyepoxide may be suitable for use as a curing agent with an acid functional polyester resin. In another non-limiting example, a blocked or internally blocked isocyanate may be suitable for use as a curing agent with an acid functional polyester resin. In another non-limiting example, dicyanamide may be suitable for use as a curing agent with an epoxy resin. Other combinations of curing agent(s) with resin(s) are encompassed by the formulations herein.

### Degassing Agent

The powder formulation can comprise a degassing agent, e.g., benzoin, benzoin coated polyamide, polyamide, polyethylene, modified forms of any of these, or a combination of any of these. In some embodiments, the powder formulation comprises a degassing agent (e.g., benzoin, benzoin coated polyamide, polyamide, a derivative form of any of these, or a combination of any of these) in a total amount of about 0.05 wt % to about 5 wt % of the formulation, e.g., about 1 wt % to about 5 wt %, about 2 wt % to about 5 wt %, about 3 wt % to about 5 wt %, about 4 wt % to about 5 wt %, about 0.05 wt % to about 4 wt %, about 0.05 wt % to about 3 wt %, about 0.05 wt % to about 2 wt %, or about 0.05 wt % to about 1 wt % of the formulation. In some embodiments, the powder formulation comprises the degassing agent in a total amount of about 0.5 wt. % to about 2 wt. % of the formulation. In some embodiments, the polyamide is an amide modified phenolated urea surfactant. In some embodiments, the modified polyethylene is polyethylene modified with polyamide.

In some embodiments, the degassing agent comprises benzoin, amide modified phenolated urea surfactant, or a combination thereof. In some embodiments, the degassing agent is present in a total amount of about 0.05 wt % to about 5 wt % of the formulation. In some embodiments, the degassing agent is present in a total amount of about 0.1 wt % to about 5 wt % of the formulation.

In some embodiments, the powder formulation comprises one or more degassing agents (e.g., any described herein) in a total amount of at least about 0.05 wt % (e.g., at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1.0 wt %, at least about 1.5 wt %, at least about 2 wt %, at least about 2.5 wt %, at least about 3 wt %, at least about 3.5 wt %, at least about 4 wt %, at least about 4.5 wt %, or at least about 5 wt %) and/or at most about 5 wt % (e.g., at most about 4.5 wt %, at most about 4 wt %, at most about 3.5 wt %, at most about 3 wt %, at most about 2.5 wt %, at most about 2 wt %, at most about 1.5 wt %, at most about 1 wt %, or at most about 0.5 wt %) of the formulation.

Non-limiting examples for degassing agents include Ceretan® MAB7055 (micronized Amide wax, coated with benzoin from Münzing Micro Technologies GmbH, Abstatt, Germany), Powdermate® 542DG (a polyamide- or amide-modified phenolated urea surfactant from Arxada-Troy Corp., Florham Park, NJ), Ceraflour® 962 (a micronized modified polyethylene wax from BYK-Chemie GmbH, Wesel, Germany), and MPP-620VF, a micronized polyethylene wax from Micro Powders Inc., Tarrytown, NY).

### Spherical Filler

In some embodiments, the powder formulation comprises a spherical filler (i.e., one or more spherical fillers). In some embodiments, the spherical filler is a precipitated amorphous (crystalline-free) silica with spherical particle shape and narrow particle size distribution. Non-limiting examples for spherical fillers include Spherilex® DP-0115 (a precipitated silica that is amorphous and non-crystalline, having a d50 particle size of about 15 μm from Evonik Corp., Parsippany, NJ) or Spheriglass® 3000E (a solid, clear, soda-lime glass in a microbead form having an average diameter of 30-50 μm from Potters Industries Inc., Paris, TX). Another non-limiting example of a spherical filler includes Spheriglass® 5000E (a solid, clear, soda-lime glass in a microbead form having an average diameter of 7-10 μm from Potters Industries Inc., Paris, TX). Another non-limiting example of a spherical filler includes barium sulfate (e.g., Cimbar™ UF supplied by Cimbar, ExBar W2 supplied by Excalibur Minerals, or Bartex 65 supplied by TOR Specialty Minerals). In some embodiments, the spherical filler comprises glass microbeads, silica, or a combination thereof.

In some embodiments, the powder formulation comprises one or more spherical fillers in a total amount of about 1 wt % to about 30 wt % of the formulation, e.g., about 1 wt % to about 29 wt %, about 1 wt % to about 28 wt %, about 1 wt % to about 27 wt %, about 1 wt % to about 26 wt %, about 1 wt % to about 25 wt %, about 1 wt % to about 24 wt %, about 1 wt % to about 23 wt %, about 1 wt % to about 22 wt %, about 1 wt % to about 21 wt %, about 1 wt % to about 20 wt %, about 1 wt % to about 19 wt %, about 1 wt % to about 18 wt %, about 1 wt % to about 17 wt %, about 1 wt % to about 16 wt %, about 1 wt % to about 15 wt %, about 1 wt % to about 14 wt %, about 1 wt % to about 13 wt %, about 1 wt % to about 12 wt %, about 1 wt % to about 11 wt %, about 1 wt % to about 10 wt %, about 1 wt % to about 9 wt %, about 1 wt % to about 8 wt %, about 1 wt % to about 7 wt %, about 1 wt % to about 6 wt %, about 1 wt % to about 5 wt %, about 1 wt % to about 4 wt %, about 1 wt % to about 3 wt %, about 2 wt % to about 17 wt %, about 2 wt % to about 16 wt %, about 2 wt % to about 15 wt %, about 2 wt % to about 14 wt %, about 2 wt % to about 13 wt %, about 2 wt % to about 12 wt %, about 2 wt % to about 12 wt %, about 2 wt % to about 10 wt %, about 2 wt % to about 9 wt %, about 2 wt % to about 8 wt %, about 2 wt % to about 7 wt %, about 2 wt % to about 6 wt %, about 2 wt % to about 5 wt %, about 2 wt % to about 4 wt %, about 2 wt % to about 3 wt %, about 4 wt % to about 17 wt %, about 4 wt % to about 16 wt %, about 4 wt % to about 15 wt %, about 4 wt % to about 14 wt %, about 4 wt % to about 13 wt %, about 4 wt % to about 12 wt %, about 4 wt % to about 14 wt %, about 4 wt % to about 10 wt %, about 4 wt % to about 9 wt %, about 4 wt % to about 8 wt %, about 4 wt % to about 7 wt %, about 4 wt % to about 6 wt %, about 4 wt % to about 5 wt %, about 1 wt % to about 5 wt %, about 5 wt % to about 10 wt %, about 10 wt % to about 15 wt %, or about 15 wt % to about 20 wt % of the formulation.

In some embodiments, the powder formulation comprises about 1 wt % to about 30 wt % of the spherical filler. In some embodiments, the powder formulation comprises one or more spherical fillers in a total amount of about 1 wt % to about 20 wt % of the formulation, e.g. about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, or about 20 wt % of the formulation. In some embodiments, the one or more spherical fillers are present in a total amount of about 1 wt % to about 20 wt % of the formulation. In some embodiments, the one or more spherical fillers are present in a total amount of about 4 wt % to about 18 wt % of the formulation. In some embodiments, the one or more spherical fillers are present in a total amount of about 2.5 wt %, about 4 wt %, about 5 wt %, or about 14 wt % of the formulation.

In some embodiments, the powder formulation comprises one or more spherical fillers (e.g., any described herein) in a total amount of at least about 1 wt % (e.g., at least about 1.5 wt %, at least about 2 wt %, at least about 2.5 wt %, at least about 3 wt %, at least about 3.5 wt %, at least about 4 wt %, at least about 4.5 wt %, or at least about 5 wt %) and/or at most about 30 wt % (e.g., at most about 25 wt %, at most about 20 wt %, at most about 15 wt %, at most about 10 wt %, at most about 8.5 wt %, at most about 8 wt %, at most about 7.5 wt %, at most about 7 wt %, at most about 6.5 wt %, at most about 6 wt %, at most about 5.5 wt %, at most about 5 wt %, at most about 4.5 wt %, at most about 4 wt %, at most about 3.5 wt %, at most about 3 wt %, at most about 2.5 wt %, at most about 2 wt %, at most about 1.5 wt %, at most about 1 wt %, or at most about 0.5 wt %) of the formulation.

In some embodiments, the one or more spherical fillers comprises a particle size from about 0.1 to 60 microns (μm), such as 0.1 μm to 55 μm, 0.1 μm to 50 μm, 0.1 μm to 45 μm, 0.1 μm to 40 μm, 0.1 μm to 35 μm, 0.1 μm to 30 μm, 0.1 μm to 25 μm, 0.1 μm to 20 μm, 0.1 μm to 15 μm, 0.1 μm to 10 μm, 0.1 μm to 5 μm, 0.1 μm to 1 μm, 0.5 μm to 55 μm, 0.5 μm to 50 μm, 0.5 μm to 45 μm, 0.5 μm to 40 μm, 0.5 μm to 35 μm, 0.5 μm to 30 μm, 0.5 μm to 25 μm, 0.5 μm to 20 μm, 0.5 μm to 15 μm, 0.5 μm to 10 μm, 0.5 μm to 5 μm, 0.5 μm to 1 μm, 1 μm to 55 μm, 1 μm to 50 μm, 1 μm to 45 μm, 1 μm to 40 μm, 1 μm to 35 μm, 1 μm to 30 μm, 1 μm to 25 μm, 1 μm to 20 μm, 1 μm to 15 μm, 1 μm to 10 μm, 1 μm to 5 μm, 5 μm to 55 μm, 5 μm to 50 μm, 5 μm to 45 μm, 5 μm to 40 μm, 5 μm to 35 μm, 5 μm to 30 μm, 5 μm to 25 μm, 5 μm to 20 μm, 5 μm to 15 μm, or 5 μm to 10 μm. In some embodiments, the one or more spherical fillers comprises an average particle size of about 1 μm to 60 μm, about 5 μm to 50 μm, about 30 μm to 50 μm, or about 7 μm to about 10 μm. In some embodiments, the one or one or more spherical fillers comprises an average particle size of about 35 microns, about 15 microns, or about 11 microns.

In some embodiments, the one or more spherical fillers are characterized by a particle size distribution (PSD) with a d50 of about 5 μm to about 50 μm, 6 μm to about 50 μm, about 7 μm to about 50 μm, about 8 μm to about 50 μm, about 9 μm to about 50 μm, about 10 μm to about 50 μm, about 11 μm to about 50 μm, about 12 μm to about 50 μm, about 13 μm to about 50 μm, about 14 μm to about 50 μm, about 15 μm to about 50 μm, about 16 μm to about 50 μm, about 17 μm to about 50 μm, about 18 μm to about 50 μm, about 19 μm to about 50 μm, about 20 μm to about 50 μm, about 5 μm to about 45 μm, about 5 μm to about 40 μm, about 5 μm to about 35 μm, about 5 μm to about 30 μm, about 5 μm to about 25 μm, about 5 μm to about 20 μm, about 5 μm to about 15 μm, or about 5 μm to about 10 μm.

In some embodiments, the one or more spherical fillers are characterized by a particle size distribution (PSD) with a d90 of about 5 μm to about 25 μm, 6 μm to about 25 μm, about 7 μm to about 25 μm, about 8 μm to about 25 μm, about 9 μm to about 25 μm, about 10 μm to about 25 μm, about 11 μm to about 25 μm, about 12 μm to about 25 μm, about 13 μm to about 25 μm, about 14 μm to about 25 μm, about 15 μm to about 25 μm, about 16 μm to about 25 μm, about 17 μm to about 25 μm, about 18 μm to about 25 μm, about 19 μm to about 25 μm, about 20 μm to about 25 μm, about 1 μm to about 25 μm, about 1 μm to about 20 μm, about 1 μm to about 15 μm, about 1 μm to about 10 μm, or about 1 μm to about 5 μm

Alternatively or in addition, the one or more spherical fillers are in some embodiments characterized by a BET specific surface area (SSA) of about 1 m²/g to about 15 m²/g, about 1 m²/g to about 14 m²/g, about 1 m²/g to about 13 m²/g, about 1 m²/g to about 12 m²/g, about 1 m²/g to about 11 m²/g, about 1 m²/g to about 10 m²/g, about 1 m²/g to about 9 m²/g, about 1 m²/g to about 8 m²/g, about 1 m²/g to about 7 m²/g, about 1 m²/g to about 6 m²/g, about 1 m²/g to about 5 m²/g, about 2 m²/g to about 15 m²/g, about 2 m²/g to about 14 m²/g, about 2 m²/g to about 13 m²/g, about 2 m²/g to about 12 m²/g, about 2 m²/g to about 11 m²/g, about 2 m²/g to about 10 m²/g, about 2 m²/g to about 9 m²/g, about 2 m²/g to about 8 m²/g, about 2 m²/g to about 7 m²/g, about 2 m²/g to about 6 m²/g, or about 2 m²/g to about 5 m²/g.

In some embodiments, the spherical filler is also a gloss reducer. In some embodiments, the spherical filler comprises precipitated silica, glass microbeads, or a combination thereof. In some embodiments, the precipitated silica and/or the glass microbeads are a gloss reducer.

In some embodiments, the powder formulation comprises glass microbeads. In some embodiments, the glass microbeads provide a cured coating having improved flexibility and/or improved impact resistance, and/or help with heat distribution upon curing.

### Amorphous Metal Silicate

In some embodiments, the powder formulation comprises an amorphous metal silicate. In some embodiments, the amorphous metal silicate is pumice or another low density vitreous particle with narrow particle size distribution. Non-limiting examples for amorphous metal silicates include SafSil® CT200 (a precipitated silica that is amorphous and non-crystalline, having a median particle size of about 12 μm from CR Minerals, Espanola, NM), SafSil® CT450 (a precipitated silica that is amorphous and non-crystalline, having a median particle size of about 7 μm from CR Minerals, Espanola, NM), SafSil® CT550 (a precipitated silica that is amorphous and non-crystalline, having a median particle size of about 5 μm from CR Minerals, Espanola, NM). In some embodiments, the amorphous metal silicate comprises pumice. In some embodiments, pumice comprises at least 70 wt. % silicon dioxide, at least 10 wt % aluminum oxide, less than 5 wt % potassium oxide, less than 5 wt % sodium oxide, less than 3 wt % calcium oxide, less than 3 wt % magnesium oxide, less than 3 wt % titanium oxide, and less than 3 wt % ferrous oxide.

In some embodiments, the powder formulation comprises an amorphous metal silicate in a total amount of about 1 wt % to about 30 wt % of the formulation, e.g., about 1 wt % to about 29 wt %, about 1 wt % to about 28 wt %, about 1 wt % to about 27 wt %, about 1 wt % to about 26 wt %, about 1 wt % to about 25 wt %, about 1 wt % to about 24 wt %, about 1 wt % to about 23 wt %, about 1 wt % to about 22 wt %, about 1 wt % to about 21 wt %, about 1 wt % to about 20 wt %, about 1 wt % to about 19 wt %, about 1 wt % to about 18 wt %, about 1 wt % to about 17 wt %, about 1 wt % to about 16 wt %, about 1 wt % to about 15 wt %, about 1 wt % to about 14 wt %, about 1 wt % to about 13 wt %, about 1 wt % to about 12 wt %, about 1 wt % to about 11 wt %, about 1 wt % to about 10 wt %, about 1 wt % to about 9 wt %, about 1 wt % to about 8 wt %, about 1 wt % to about 7 wt %, about 1 wt % to about 6 wt %, about 1 wt % to about 5 wt %, about 1 wt % to about 4 wt %, about 1 wt % to about 3 wt %, about 2 wt % to about 17 wt %, about 2 wt % to about 16 wt %, about 2 wt % to about 15 wt %, about 2 wt % to about 14 wt %, about 2 wt % to about 13 wt %, about 2 wt % to about 12 wt %, about 2 wt % to about 12 wt %, about 2 wt % to about 10 wt %, about 2 wt % to about 9 wt %, about 2 wt % to about 8 wt %, about 2 wt % to about 7 wt %, about 2 wt % to about 6 wt %, about 2 wt % to about 5 wt %, about 2 wt % to about 4 wt %, about 2 wt % to about 3 wt %, about 4 wt % to about 17 wt %, about 4 wt % to about 16 wt %, about 4 wt % to about 15 wt %, about 4 wt % to about 14 wt %, about 4 wt % to about 13 wt %, about 4 wt % to about 12 wt %, about 4 wt % to about 14 wt %, about 4 wt % to about 10 wt %, about 4 wt % to about 9 wt %, about 4 wt % to about 8 wt %, about 4 wt % to about 7 wt %, about 4 wt % to about 6 wt %, about 4 wt % to about 5 wt %, about 1 wt % to about 5 wt %, about 5 wt % to about 10 wt %, about 10 wt % to about 15 wt %, or about 15 wt % to about 20 wt % of the formulation. In some embodiments, the powder formulation comprises one or more amorphous metal silicates in a total amount of about 1 wt % to about 20 wt % of the formulation, e.g. about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, or about 10.5 wt % of the formulation. In some embodiments, the powder formulation comprises one or more amorphous metal silicates in a total amount of about 1 wt % to about 30 wt % of the formulation. In some embodiments, the powder formulation comprises one or more amorphous metal silicates in a total amount of about 1 wt % to about 10 wt % of the formulation. In some embodiments, the powder formulation comprises one or more amorphous metal silicates in a total amount of about 1 wt % to about 5 wt % of the formulation.

In some embodiments, the powder formulation comprises one or more amorphous metal silicates (e.g., any described herein) in a total amount of at least about 1 wt % (e.g., at least about 1.5 wt %, at least about 2 wt %, at least about 2.5 wt %, at least about 3 wt %, at least about 3.5 wt %, at least about 4 wt %, at least about 4.5 wt %, or at least about 5 wt %) and/or at most about 30 wt % (e.g., at most about 25 wt %, at most about 20 wt %, at most about 15 wt %, at most about 10 wt %, at most about 8.5 wt %, at most about 8 wt %, at most about 7.5 wt %, at most about 7 wt %, at most about 6.5 wt %, at most about 6 wt %, at most about 5.5 wt %, at most about 5 wt %, at most about 4.5 wt %, at most about 4 wt %, at most about 3.5 wt %, at most about 3 wt %, at most about 2.5 wt %, at most about 2 wt %, at most about 1.5 wt %, at most about 1 wt %, or at most about 0.5 wt %) of the formulation.

In some embodiments, the amorphous metal silicate comprises a median particle size from about 0.1 to 30 microns (μm), such as 0.1 μm to 25 μm, 0.1 μm to 20 μm, 0.1 μm to 15 μm, 0.1 μm to 10 μm, 0.1 μm to 5 μm, 0.1 μm to 1 μm, 0.5 μm to 30 μm, 0.5 μm to 25 μm, 0.5 μm to 20 μm, 0.5 μm to 15 μm, 0.5 μm to 10 μm, 0.5 μm to 5 μm, 0.5 μm to 1 μm, 1 μm to 30 μm, 1 μm to 25 μm, 1 μm to 20 μm, 1 μm to 15 μm, 1 μm to 10 μm, 1 μm to 5 μm, 5 μm to 30 μm, 5 μm to 25 μm, 5 μm to 20 μm, 5 μm to 15 μm, or 5 μm to 10 μm. In some embodiments, the amorphous metal silicate comprises a median particle size of about 5 μm. In some embodiments, the amorphous metal silicate comprises a median particle size of about 7 μm. In some embodiments, the amorphous metal silicate comprises a median particle size of about 12 μm.

### Catalyst

The powder formulation comprises a catalyst. Any suitable catalyst can be used in the powder formulation, e.g., a catalyst that accelerates the reaction of the acid functional polyester resin with the curing agent. In some embodiments, the catalyst comprises a phase transfer catalyst.

In some embodiments, the polyester resin comprises the catalyst (i.e., the polyester resin is pre-catalyzed). As used herein, “pre-catalyzed” refers to a resin having catalyst dispersed throughout the resin. In some embodiments, the catalyst added directly with the polyester resin, and optionally the curing agent and other components in the formulation and dispersed well prior to processing (i.e., mixing with other components). In some embodiments, wherein the polyester resin is pre-catalyzed, additional catalyst is not required or added at a minimal level to the powder formulation. In some embodiments, the pre-catalyzed polyester resin provides improved uniform dispersion of the catalyst in the powder formulation. In some embodiments, the pre-catalyzed polyester resin minimizes weighing errors during preparation of the powder formulation, providing improved consistency in producing high-quality powder coatings.

In some embodiments, the powder formulation comprises the catalyst in a total amount of about 0.05 wt % to about 10 wt % of the formulation, e.g., about 0.05 wt % to about 6 wt %, about 0.5 wt % to about 5 wt %, about 1 wt % to about 5 wt %, about 2 wt % to about 5 wt %, about 3 wt % to about 5 wt %, about 4 wt % to about 5 wt %, about 0.1 wt % to about 4 wt %, about 0.1 wt % to about 3 wt %, about 0.1 wt % to about 2 wt %, about 0.1 wt % to about 1 wt %, about 0.1 wt % to about 0.5 wt %, about 0.2 wt % to about 5 wt %, about 0.2 wt % to about 4 wt %, about 0.2 wt % to about 3 wt %, about 0.2 wt % to about 2 wt %, about 0.2 wt % to about 1 wt %, or about 0.2 wt % to about 0.5 wt % of the formulation. In some embodiments, the powder formulation comprises the catalyst in a total amount of about 0.1 wt %, 0.15 wt %, 0.2 wt %, 0.25 wt %, 0.3 wt %, 0.35 wt %, 0.4 wt %, 0.45 wt %, 0.5 wt %, 0.55 wt %, 0.6 wt %, 0.65 wt %, 0.7 wt %, 0.75 wt %, 0.8 wt %, 0.85 wt %, 0.9 wt %, or 0.95 wt % of the formulation. In some embodiments, the powder formulation comprises about 0.1 wt % to about 6 wt % of the catalyst. In some embodiments, the catalyst is present in a total amount of about 0.1 wt % to about 5 wt % of the formulation. In some embodiments, the catalyst is present in a total amount of about 0.2 wt % to about 2 wt % of the formulation. In some embodiments, the catalyst is present in a total amount of about 0.1 wt % to about 0.6 wt % of the formulation. In some embodiments, the catalyst is present in a total amount of about 0.45 wt % of the formulation.

In some embodiments, the powder formulation comprises the catalyst in a total amount of at least about 0.01 wt % (e.g., at least about 0.05 wt %, at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1.0 wt %, at least about 1.5 wt %, at least about 2 wt %, at least about 2.5 wt %, at least about 3 wt %, at least about 3.5 wt %, at least about 4 wt %, or at least about 4.5 wt %) and/or at most about 5 wt % (e.g., at most about 4.5 wt %, at most about 4 wt %, at most about 3.5 wt %, at most about 3 wt %, at most about 2.5 wt %, at most about 2 wt %, at most about 1.5 wt %, at most about 1 wt %, or at most about 0.5 wt %) of the formulation.

In some embodiments, the catalyst is a phase-transfer catalyst, e.g., an ammonium salt, a phosphonium salt (e.g., optionally adsorbed on a solid carrier), or a combination thereof. In some embodiments, the ammonium salt is N⁺(R²)₄X⁻, and wherein each R² is, independently, hydrogen (H) or an optionally substituted C1-18 hydrocarbyl group (e.g., alkyl, haloalkyl, aryl, alkaryl, aralkyl) and X is an anion. In some embodiments, the phosphonium salt is P⁺(R³)₄X⁻, and wherein each R³ is, independently, hydrogen (H) or an optionally substituted C1-18 hydrocarbyl group (e.g., alkyl, haloalkyl, aryl, alkaryl, aralkyl) and X is an anion.

Non-limiting hydrocarbyl groups include alkyl, alkenyl, alkynyl, aryl, alkaryl (e.g., —Ar-Ak, in which Ar is a multivalent aryl group and Ak is an alkyl group), and aralkyl (e.g., -Ak-Ar, in which Ak is a multivalent alkyl group and Ar is an aryl group). Non-limiting examples of alkyl include methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, and tetracosyl. The alkyl group can be cyclic (e.g., C3-24 cycloalkyl) or acyclic. The alkyl group can be a primary, secondary, or tertiary alkyl group substituted with one or more substituents (e.g., one or more halo, alkoxy, acyl). The hydrocarbyl group can be substituted with one or more substituents (e.g., one or more of halo (e.g., F, Cl, Br, or I), alkoxy (e.g., —OR, in which R is alkyl as described herein), and acyl (e.g., —C(O)R, in which R is H or alkyl as described herein)). In some embodiments, the unsubstituted hydrocarbyl group or alkyl group is a C1-3, C1-6, C1-12, C1-16, C1-18, C1-20, C1-24, C2-3, C2-6, C2-12, C2-16, C2-18, C2-20, or C2-24 hydrocarbyl group or alkyl group. Non-limiting examples of aryl include benzyl, naphthalene, phenyl, biphenyl, and phenoxybenzene. The aryl group can optionally include one or more heteroatoms. The aryl group can be substituted with one or more substituents (e.g., one or more halo, alkyl, alkoxy, acyl). In particular embodiments, an unsubstituted aryl group is a C4-18, C4-14, C4-12, C4-10, C6-18, C6-14, C6-12, or C6-10 aryl group.

Non-limiting anions include halide (e.g., chloride, bromide, iodide, or fluoride), sulfate, bisulfate, sulfite, bisulfite, carbonate, bicarbonate, hypochlorite, perchlorate, chlorate, phosphate, monohydrogen phosphate, acetate, formate, and oxalate. Another non-limiting anion is borate. In some embodiments, the anion is chloride, bromide, borate, or acetate.

In some embodiments, the ammonium salt includes a tetraalkylammonium halide (e.g., N⁺(R²)₄X⁻, and wherein each R² is, independently, an optionally substituted C1-18 alkyl and X is an anion). Non-limiting examples include benzyltriethylammonium chloride, benzyltrimethylammonium chloride, tetrabutylammonium bromide, tetrabutylammonium chloride, tetrabutylammonium iodide, tetradecylammonium bromide, tetradecylammonium chloride, tetradecylammonium iodide, butyl triethyl ammonium bromide, butyl triethyl ammonium chloride, or a combination thereof. In some embodiments, the phase-transfer catalyst is benzyltriethylammonium chloride.

In some embodiments, the phosphonium salt comprises a phosphonium halide (e.g., P⁺(R³)₄X⁻, in which each R³ is H and X is an anion, such as phosphonium bromide, phosphonium chloride, and phosphonium iodide), an aryl phosphonium halide (e.g., P⁺(R³)₄X⁻, in which at least one R³ is optionally substituted aryl and X is an anion, such as triphenyl phosphonium bromide, triphenyl phosphonium chloride, and triphenyl phosphonium iodide), or an alkyl phosphonium halide (e.g., P⁺(R³)₄X⁻, in which at least one R³ is optionally substituted alkyl and X is an anion, such as tetrabutyl phosphonium bromide, tetrabutyl phosphonium chloride, and tetrabutyl phosphonium iodide), or a combination thereof.

In some embodiments, the powder formulation comprises a catalyst, wherein the catalyst is a phase transfer catalyst. In some embodiments, the powder formulation comprises a phase-transfer catalyst (e.g., an ammonium salt, a phosphonium salt, or combinations thereof) in a total amount of about 0.05 wt % to about 10 wt % of the formulation. In some embodiments, the powder formulation comprises a phase-transfer catalyst (e.g., an ammonium salt, a phosphonium salt, or combinations thereof) in a total amount of about 0.1 wt % to about 5 wt % of the formulation, e.g., about 0.5 wt % to about 5 wt %, about 1 wt % to about 5 wt %, about 2 wt % to about 5 wt %, about 3 wt % to about 5 wt %, about 4 wt % to about 5 wt %, about 0.1 wt % to about 4 wt %, about 0.1 wt % to about 3 wt %, about 0.1 wt % to about 2 wt %, about 0.1 wt % to about 1 wt %, about 0.1 wt % to about 0.5 wt %, about 0.2 wt % to about 5 wt %, about 0.2 wt % to about 4 wt %, about 0.2 wt % to about 3 wt %, about 0.2 wt % to about 2 wt %, about 0.2 wt % to about 1 wt %, or about 0.2 wt % to about 0.5 wt % of the formulation. In some embodiments, the powder formulation comprises a phase-transfer catalyst (e.g., an ammonium salt, a phosphonium salt, or combinations thereof) in a total amount of about 0.1 wt %, 0.15 wt %, 0.2 wt %, 0.25 wt %, 0.3 wt %, 0.35 wt %, 0.4 wt %, 0.45 wt %, 0.5 wt %, 0.55 wt %, 0.6 wt %, 0.65 wt %, 0.7 wt %, 0.75 wt %, 0.8 wt %, 0.85 wt %, 0.9 wt %, or 0.95 wt % of the formulation. In some embodiments, the powder formulation comprises a phase-transfer catalyst in a total amount of about 0.05 wt. % to about 6 wt. %, or about 0.3 wt % to about 0.55 wt % of the formulation.

In some embodiments, the powder formulation comprises one or more phase-transfer catalysts (e.g., any described herein) in a total amount of at least about 0.01 wt % (e.g., at least about 0.05 wt %, at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1.0 wt %, at least about 1.5 wt %, at least about 2 wt %, at least about 2.5 wt %, at least about 3 wt %, at least about 3.5 wt %, at least about 4 wt %, or at least about 4.5 wt %) and/or at most about 5 wt % (e.g., at most about 4.5 wt %, at most about 4 wt %, at most about 3.5 wt %, at most about 3 wt %, at most about 2.5 wt %, at most about 2 wt %, at most about 1.5 wt %, at most about 1 wt %, or at most about 0.5 wt %) of the formulation.

Non-limiting examples for phase-transfer catalysts include Actiron® 43-65 (tetrabutylammonium bromide adsorbed on silica from Synthron, Essex, U.K.), Aradur® DT 3126-2 (curing accelerator from Huntsman, The Woodlands, TX), and benzyltriethylammonium chloride (BTEAC).

In some embodiments, the formulation further comprises a phase transfer additive agent. Non-limiting examples for phase transfer additives agents include Actiron® 43-65 (tetabutylammonium bromide adsorbed on silica), Aradur® DT 3126-2 (10% tetradecylammonium bromide in polyester resin), Chartsil C523.2H (hybrid carboxy/hydroxy functional metal organic adhesion promoter; propylene glycol with hydroxy/carboxy functionality and 72 wt. % Chartwell C523.2H).

### Flow Modifier

The powder formulation can comprise a flow modifier, e.g., an acrylic polymer such as an absorbed acrylic polymer on a particle, polysiloxane, or a fluorocarbon. In some embodiments, the flow modifier comprises an acrylic polymer, silica, or a combination thereof. In some embodiments, the flow modifier comprises an acrylic polymer (e.g., poly(methyl acrylate), poly(ethyl acrylate), poly(butyl acrylate), poly(isobutyl acrylate), or poly(ethylhexyl acrylate). In some embodiments, the flow modifier further comprises amorphous precipitated silica.

In some embodiments, the powder formulation comprises a flow modifier (e.g., an acrylic polymer such as an absorbed acrylic polymer on a particle, polysiloxane, a fluorocarbon) in a total amount of about 0.1 wt % to about 5 wt % of the formulation, e.g., about 0.5 wt % to about 5 wt %, about 1 wt % to about 5 wt %, about 2 wt % to about 5 wt %, about 3 wt % to about 5 wt %, about 4 wt % to about 5 wt %, about 0.1 wt % to about 4 wt %, about 0.1 wt % to about 3 wt %, about 0.1 wt % to about 2 wt %, about 0.1 wt % to about 1 wt %, about 0.1 wt % to about 0.5 wt %, about 0.2 wt % to about 4 wt %, about 0.2 wt % to about 3 wt %, about 0.2 wt % to about 2 wt %, about 0.2 wt % to about 1 wt %, or about 0.2 wt % to about 0.5 wt % of the formulation. In some embodiments, the powder formulation comprises a flow modifier in a total amount of about 0.1 wt %, 0.15 wt %, 0.2 wt %, 0.25 wt %, 0.3 wt %, 0.35 wt %, 0.4 wt %, 0.45 wt %, 0.5 wt %, 0.55 wt %, 0.6 wt %, 0.65 wt %, 0.7 wt %, 0.75 wt %, 0.8 wt %, 0.85 wt %, 0.9 wt %, or 0.95 wt % of the formulation. In some embodiments, the powder formulation comprises the flow modifier in a total amount of about 0.1 wt. % to about 2 wt. % of the formulation. In some embodiments, the flow modifier is present in a total amount of about 0.5 wt. % to about 2 wt. % of the formulation. In some embodiments, the flow modifier is present in a total amount of about 0.8 wt. % of the formulation.

In some embodiments, the powder formulation comprises one or more flow modifiers (e.g., any described herein) in a total amount of at least about 0.1 wt % (e.g., at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1.0 wt %, at least about 1.5 wt %, at least about 2 wt %, at least about 2.5 wt %, at least about 3 wt %, at least about 3.5 wt %, at least about 4 wt %, or at least about 4.5 wt %) and/or at most about 5 wt % (e.g., at most about 4.5 wt %, at most about 4 wt %, at most about 3.5 wt %, at most about 3 wt %, at most about 2.5 wt %, or at most about 2 wt %) of the formulation.

In some embodiments, the flow modifier comprises an acrylic polymer. In some embodiments, the acrylic polymer further comprises an adsorbed acrylic polymer on a particle. In some embodiments, the flow modifier further comprises amorphous precipitated silica.

Non-limiting examples for flow modifiers include Resiflow® PH-241 (mixture of acrylic polymer and silica from Estron Chemicals, Inc., Calvert City, KY), Resiflow® PL-200 or Resiflow® PL-230 (mixture of acrylic polymer and silica from Estron Chemicals, Inc., Calvert City, KY), Resiflow® PL-200A (mixture of acrylic polymer and silica from Estron Chemicals, Inc., Calvert City, KY), Resiflow® PL-230 (mixture of acrylic polymer and silica from Estron Chemicals, Inc., Calvert City, KY), Resiflow® PL-330 (mixture of acrylic polymer and silica from Estron Chemicals, Inc., Calvert City, KY), Modaflow® Powder III (silicone free resin from Allnex, Frankfurt, Germany), Floaid MAPS-P (60% polysiloxane from Danick Specialties & Support, Inc., Niceville, FL), and Floaid FC-4 (70% fluorochemical surfactant from Danick Specialties & Support, Inc., Niceville, FL).

In some embodiments, the flow modifier also acts as an anti-crater additive.

### Transfer Efficiency Additive

In some embodiments, the powder formulation comprises a transfer efficiency additive, e.g., a ceramic (e.g., barium titanate, zirconium titanate, or a combination thereof). In some embodiments, the transfer efficiency additive is selected from titanium-containing compounds (e.g., lithium titanate, strontium titanate, barium strontium titanate, potassium niobate, sodium niobate, or a combination of any of these), a metal oxide (e.g., aluminum oxide, chromium oxide, titanium oxide, zirconium oxide, or a combination of any of these), or a combination of any of these. In some embodiments, the powder formulation comprises about 0.1 wt % to about 5 wt % of the transfer efficiency additive.

In some embodiments, the powder formulation comprises a transfer efficiency additive (e.g., barium titanate) in a total amount of about 0.1 wt % to about 5 wt % of the formulation, e.g., about 1 wt % to about 5 wt %, about 1 wt % to about 4 wt %, about 1 wt % to about 3 wt %, about 1 wt % to about 4 wt %, about 2.5 wt % to about 5 wt %, about 0.1 wt % to about 1 wt %, about 0.1 wt % to about 2 wt %, about 0.1 wt % to about 3 wt %, about 0.1 wt % to about 5 wt %, about 0.2 wt % to about 1 wt %, about 0.2 wt % to about 2 wt %, about 0.2 wt % to about 3 wt %, about 0.2 wt % to about 5 wt %, about 0.5 wt % to about 1.5 wt %, about 0.5 wt % to about 2.5 wt %, about 0.5 wt % to about 3.5 wt %, or about 0.5 wt % to about 4.5 wt %. In some embodiments, the powder formulation comprises a transfer efficiency additive in a total amount of about 0.1 wt %, 0.15 wt %, 0.2 wt %, 0.25 wt %, 0.3 wt %, 0.35 wt %, 0.4 wt %, 0.45 wt %, 0.5 wt %, 0.55 wt %, 0.6 wt %, 0.65 wt %, 0.7 wt %, 0.75 wt %, 0.8 wt %, 0.85 wt %, 0.9 wt %, or 0.95 wt % of the formulation. In some embodiments, the transfer efficiency additive is present in a total amount of about 0.2 wt % to about 2 wt % of the formulation. In some embodiments, the transfer efficiency additive is present in a total amount of about 0.75 wt % of the formulation.

In some embodiments, the transfer efficiency additive comprises barium titanate, zirconium titanate, strontium titanate, barium strontium titanate, potassium niobate, sodium niobate, a carboxylic acid ester, or a combination thereof. In some embodiments, the transfer efficiency additive comprises barium titanate, zirconium titanate, strontium titanate, barium strontium titanate, potassium niobate, sodium niobate, or a combination thereof. In some embodiments, the transfer efficiency additive comprises barium titanate, a carboxylic acid ester, or a combination thereof. In some embodiments, the transfer efficiency additive comprises barium titanate.

In some embodiments, the powder formulation comprises one or more transfer efficiency additives (e.g., any described herein) in a total amount of at least about 0.05 wt % (e.g., at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1.0 wt %, at least about 1.5 wt %, at least about 2 wt %, at least about 2.5 wt %, at least about 3 wt %, at least about 3.5 wt %, at least about 4 wt %, or at least about 4.5 wt %) and/or at most about 10 wt % (e.g., at most about 8 wt %, at most about 7 wt %, at most about 6 wt %, at most about 5.5 wt %, at most about 5 wt %, at most about 4.5 wt %, at most about 4 wt %, at most about 3.5 wt %, at most about 3 wt %, at most about 2.5 wt %, at most about 2 wt %, at most about 1.5 wt %, or at most about 1 wt %) of the formulation.

### Antistatic Agent

In some embodiments, the powder formulation comprises an antistatic agent, e.g., long-chain aliphatic amines, long-chain aliphatic amides, quaternary ammonium salts (e.g., behentrimonium chloride or cocamidopropyl betaine), esters of phosphoric acid, polyethylene glycol esters, polyols, and combinations thereof). Non-limiting examples for antistatic agents include carboxylic acid esters, e.g., Lanco™ Stats from Lubrizol, Wickliffe, OH, e.g., Lanco™ Stat 308, Lanco™ Stat LI 100, Lanco™ Stat K 100 N, Lanco™ Stat FN, Lanco™ Stat PUN, and Lanco™ Stat L 80N.

In some embodiments, the antistatic agent is the transfer efficiency additive (i.e., the antistatic agent and the transfer efficiency additive are the same component). In some embodiments, the antistatic agent comprises a carboxylic acid ester, wherein the carboxylic acid ester also acts as a transfer efficiency additive. In some embodiments, the antistatic agent is different from the transfer efficiency additive.

In some embodiments, the antistatic agent acts as a co-crosslinker. In some embodiments, the antistatic agent comprises an isocyanate (e.g., a polyisocyanate, an isocyanate adduct, an aliphatic polyisocyanate, a cycloaliphatic polyisocyanate), a glycidyl ester (e.g., glycidyl methacrylate, triglycidyl trimellitate, diglycidyl terephthalate), a hydroxyalkylamide (e.g., β-hydroxyalkylamide), or a combination thereof. In some embodiments, the hydroxyalkylamide is (R¹)₂NC(O)-Ak-C(O)N(R¹)₂ (e.g., as described herein). Non-limiting examples for crosslinking agents include Primid® XL-552 (a hydroxyalkylamide from Ems-Chemie, Domat/EMS, Switzerland), and Primid® SF-4510 (a hydroxyalkylamide from Ems-Chemie, Domat/EMS, Switzerland).

In some embodiments, the powder formulation comprises about 0.1 wt % to about 5 wt % of the antistatic agent, optionally wherein the antistatic agent is the transfer efficiency additive. In some embodiments, the powder formulation comprises an antistatic agent in a total amount of about 0.1 wt % to about 5 wt % of the formulation, e.g., about 1 wt % to about 5 wt %, about 1 wt % to about 4 wt %, about 1 wt % to about 3 wt %, about 1 wt % to about 4 wt %, about 2.5 wt % to about 5 wt %, about 0.1 wt % to about 1 wt %, about 0.1 wt % to about 2 wt %, about 0.1 wt % to about 3 wt %, about 0.1 wt % to about 5 wt %, about 0.2 wt % to about 1 wt %, about 0.2 wt % to about 2 wt %, about 0.2 wt % to about 3 wt %, about 0.2 wt % to about 5 wt %, about 0.5 wt % to about 1.5 wt %, about 0.5 wt % to about 2.5 wt %, about 0.5 wt % to about 3.5 wt %, or about 0.5 wt % to about 4.5 wt %. In some embodiments, the powder formulation comprises an antistatic agent in a total amount of about 0.1 wt %, 0.15 wt %, 0.2 wt %, 0.25 wt %, 0.3 wt %, 0.35 wt %, 0.4 wt %, 0.45 wt %, 0.5 wt %, 0.55 wt %, 0.6 wt %, 0.65 wt %, 0.7 wt %, 0.75 wt %, 0.8 wt %, 0.85 wt %, 0.9 wt %, or 0.95 wt % of the formulation. In some embodiments, the powder formulation comprises an antistatic agent in a total amount of about 0.1 wt. % to about 2.5 wt. %, or about 0.1 wt % to about 1 wt % of the formulation. In some embodiments, the antistatic agent is present in a total amount of about 0.1 wt % to about 2 wt % of the formulation. In some embodiments, the antistatic agent is present in a total amount of about 0.5 wt % of the formulation.

In some embodiments, the powder formulation comprises one or more antistatic agents (e.g., any described herein) in a total amount of at least about 0.05 wt % (e.g., at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1 wt %, at least about 1.2 wt %, or at least about 1.5 wt %) and/or at most about 5 wt % (e.g., at most about 4.5 wt %, at most about 4 wt %, at most about 3.5 wt %, at most about 3 wt %, at most about 2.5 wt %, at most about 2 wt %, or at most about 1.5 wt %) of the formulation.

Depending on the resin and/or curing agent present in the formulation, a crosslinking agent can be selected based on its reactivity with the functional groups present on the resin and the reactive groups of the curing agent. In some embodiments, the amount and type of crosslinking agent can be selected to further catalyze or react remaining functional groups and reactive groups provided by the resin and curing agent. For example, a crosslinking agent can be used to minimize the amount of unreacted resin or curing agent in the powder formulation. Accordingly, a suitable type and/or a suitable amount of crosslinking agent can be selected to minimize the amount of unreacted resin and/or unreacted curing agent in the powder formulation.

In some embodiments, a crosslinking agent acts as both a crosslinking agent and an antistatic agent, depending on the reactive group present on the crosslinking agent and the functional groups present on the resin. Accordingly, in some non-limiting embodiments, the powder formulation comprises a crosslinking agent that acts as both a crosslinking agent and an antistatic agent.

### Gloss Reducer

In some embodiments, the powder formulation comprises a gloss reducer (i.e., a matting agent). In some embodiments, the gloss reducer is a compound or a blend of compounds for adding a smooth texture effect with some gloss control in powder coatings. In some embodiments, the gloss reducer comprises micronized wax, a functionalized epoxy, a blend of polytetrafluoroethylene and polyethylene, a blend of polytetrafluoroethylene and synthetic wax, or a combination thereof. In some embodiments, the gloss reducer comprises micronized wax.

In some embodiments, the powder formulation comprises about 0.1 wt % to about 40 wt % of a gloss reducer. In some embodiments, the powder formulation comprises about 1 wt % to about 40 wt %, 1 wt % to about 30 wt %, about 1 wt % to about 20 wt %, about 1 wt % to about 10 wt %, about 0.1 wt % to about 5 wt %, about 10 wt % to about 40 wt %, about 20 wt % to about 40 wt %, or about 30 wt % to about 40 wt % of a gloss reducer.

In some embodiments, the powder formulation comprises a gloss reducer in a total amount of about 1 wt % to about 5 wt % of the formulation, e.g., about 1 wt % to about 5 wt %, about 2 wt % to about 5 wt %, about 3 wt % to about 5 wt %, about 4 wt % to about 5 wt %, about 1 wt % to about 4 wt %, about 1 wt % to about 3 wt %, about 1 wt % to about 2 wt % of the formulation. In some embodiments, the powder formulation comprises a gloss reducer in a total amount of about 1 wt %, 1.5 wt %, 2.0 wt %, 2.5 wt %, 3 wt %, 3.5 wt %, 4 wt %, 4.5 wt %, or 5 wt % of the formulation. In some embodiments, the powder formulation comprises one or more gloss reducers in a total amount of about 10 wt. % to about 50 wt. %, about 10 wt. % to about 40 wt. %, about 10 wt. % to about 25 wt. %, or about 35 wt. % to about 40 wt. % of the formulation. In some embodiments, the gloss reducer includes wax, including synthetic or bio-based waxes. In some embodiments, the gloss reducer includes wax, glass microbeads, precipitated silica, or a combination thereof. In some embodiments, the gloss reducer includes a functional epoxy resin.

In some embodiments, the powder formulation comprises one or more gloss reducers (e.g., any described herein) in a total amount of at least about 0.1 wt % (e.g., at least about 0.2 wt %, at least about 0.3 wt %, at least about 0.4 wt %, at least about 0.5 wt %, at least about 1.0 wt %, at least about 1.5 wt %, at least about 2 wt %, at least about 3 wt %, at least about 4 wt %, at least about 5 wt %, at least about 6 wt %, at least about 7 wt %, at least about 8 wt %, at least about 9 wt %, or at least about 10 wt %) and/or at most about 40 wt % (e.g., at most about 30 wt %, at most about 20 wt %, at most about 15 wt %, at most about 10 wt %, at most about 9 wt %, at most about 8 wt %, at most about 7 wt %, at most about 6 wt %, at most about 5 wt %, at most about 4 wt %, at most about 3 wt %, at most about 2 wt %, at most about 1 wt %) of the formulation.

Non-limiting examples for a gloss reducer include Synfluo® 283 (blend of high molecular weight polytetrafluoroethylene and synthetic wax from Micro Powders, Inc., Tarrytown, NY) and MP-22 (micronized Fischer-Tropsch wax from Micro Powders, Inc., Tarrytown, NY). Another non-limiting example of a gloss reducer includes a blend of polytetrafluoroethylene and polyethylene (e.g., TF 1830 from Lanco™ TF 1830 Micronized Wax). In some embodiments, the gloss reducer comprises a blend of high molecular weight polytetrafluoroethylene and synthetic wax. In some embodiments, the blend of high molecular weight polytetrafluoroethylene and synthetic wax enhances starch and mar resistance, reduce flow, provide a fine texture, and/or provide a writable surface appearance. In some embodiments, the gloss reducer also acts as a wetting agent.

### Other Components

The powder formulation can include one or more other components, such as a crystalline resin, a thermoplastic additive, an adhesion promoter, a co-crosslinker, a viscosity modifier, an antimicrobial agent, a rheology modifier, or a pigment, or a combination of any of these. In some embodiments, the powder formulation comprises a combination of a crystalline resin, a thermoplastic additive, a viscosity modifier, an adhesion promoter, and one or more antimicrobial agents. In some embodiments, the powder formulation comprises a combination of a crystalline resin, a thermoplastic additive, a gloss reducer, and one or more antimicrobial agents. In some embodiments, the powder formulation comprises a thermoplastic additive. In some embodiments, the powder formulation comprises a combination of an adhesion promoter and a gloss reducer. In some embodiments, the powder formulation comprises the spherical filler, the amorphous metal silicate, and the thermoplastic additive.

The powder formulation can comprise a crystalline resin, e.g., a carboxylated polyester. In some embodiments, the powder formulation comprises a crystalline resin in a total amount of about 0.1 wt % to about 30 wt % of the formulation, e.g., about 0.5 wt % to about 30 wt %, about 1 wt % to about 30 wt %, about 2 wt % to about 30 wt %, about 3 wt % to about 30 wt %, about 4 wt % to about 30 wt %, about 5 wt % to about 30 wt %, about 6 wt % to about 30 wt %, about 7 wt % to about 30 wt %, about 8 wt % to about 30 wt %, about 9 wt % to about 30 wt %, about 10 wt % to about 30 wt %, about 12 wt % to about 30 wt %, about 15 wt % to about 30 wt %, about 18 wt % to about 30 wt %, about 20 wt % to about 30 wt %, about 22 wt % to about 30 wt %, about 25 wt % to about 30 wt %, about 28 wt % to about 30 wt %, about 0.5 wt % to about 10 wt %, about 1 wt % to about 10 wt %, about 2 wt % to about 10 wt %, about 3 wt % to about 10 wt %, about 4 wt % to about 10 wt %, about 0.5 wt % to about 5 wt %, about 1 wt % to about 5 wt %, about 2 wt % to about 5 wt %, about 3 wt % to about 5 wt %, about 4 wt % to about 5 wt %, about 0.1 wt % to about 9 wt %, about 0.1 wt % to about 8 wt %, about 0.1 wt % to about 7 wt %, about 0.1 wt % to about 6 wt %, about 0.1 wt % to about 5 wt %, about 0.1 wt % to about 4 wt %, about 0.1 wt % to about 3 wt %, about 0.1 wt % to about 2 wt %, about 0.1 wt % to about 1 wt %, or about 0.1 wt % to about 0.5 wt % of the formulation. In some embodiments, the powder formulation comprises a crystalline resin in a total amount of about 0.1 wt %, 0.15 wt %, 0.2 wt %, 0.25 wt %, 0.3 wt %, 0.35 wt %, 0.4 wt %, 0.45 wt %, 0.5 wt %, 0.55 wt %, 0.6 wt %, 0.65 wt %, 0.7 wt %, 0.75 wt %, 0.8 wt %, 0.85 wt %, 0.9 wt %, or 0.95 wt % of the formulation. In some embodiments, the crystalline resin is present in a total amount of about 1 wt % to about 30 wt % of the formulation. In some embodiments, the crystalline resin is present in a total amount of about 1 wt % to about 15 wt % of the formulation. In some embodiments, the crystalline resin is present in a total amount of about 1 wt % to about 10 wt % of the formulation.

In some embodiments, the powder formulation comprises one or more crystalline resins (e.g., any described herein) in a total amount of at least about 0.05 wt % (e.g., at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1 wt %, at least about 1.2 wt %, or at least about 1.5 wt %) and/or at most about 30 wt % (e.g., at most about 25 wt %, at most about 20 wt %, at most about 15 wt %, at most about 10 wt %, at most about 5 wt %, at most about 4.5 wt %, at most about 4 wt %, at most about 3.5 wt %, at most about 3 wt %, at most about 2.5 wt %, at most about 2 wt %, or at most about 1.5 wt %) of the formulation.

Non-limiting examples for a crystalline resin include Uralac® P 9000 (a carboxylated polyester resin having an acid value from 46-50 and a viscosity of 100-2,000 mPa·s at 160° C.) from Covestro AG, Leverkusen, Germany; and Sirales® PE 5900 (a carboxylated polyester resin having an acid value from 25-70 and a viscosity of 1500 mPa·s at 125° C.) from Sir Industriale SPA.

The powder formulation can comprise a thermoplastic additive, e.g., a compound that improves the post-embrittlement. In some embodiments, the powder formulation comprises a thermoplastic additive in a total amount of about 0.5 wt % to about 5 wt % of the formulation, e.g., about 1 wt % to about 5 wt %, about 2 wt % to about 5 wt %, about 3 wt % to about 5 wt %, about 4 wt % to about 5 wt %, about 0.5 wt % to about 4 wt %, about 0.5 wt % to about 3 wt %, or about 0.5 wt % to about 2 wt %, about 0.5 wt % to about 1 wt %, about 1 wt % to about 4 wt %, about 1 wt % to about 3 wt %, or about 1 wt % to about 2 wt % of the formulation. In some embodiments, the powder formulation comprises a thermoplastic additive in a total amount of about 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2.0 wt %, 2.5 wt %, 3 wt %, 3.5 wt %, 4 wt %, 4.5 wt %, or 5 wt % of the formulation.

In some embodiments, the powder formulation comprises one or more thermoplastic additives (e.g., any described herein) in a total amount of at least about 0.05 wt % (e.g., at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1 wt %, at least about 1.2 wt %, or at least about 1.5 wt %) and/or at most about 10 wt % (e.g., at most about 9 wt %, at most about 8 wt %, at most about 7 wt %, at most about 6 wt %, at most about 5 wt %, at most about 4.5 wt %, at most about 4 wt %, at most about 3.5 wt %, at most about 3 wt %, at most about 2.5 wt %, at most about 2 wt %, or at most about 1.5 wt %) of the formulation.

Non-limiting examples for a thermoplastic additive include Griltex® D2132 EP82 (a copolyester from Ems-Chemie, Domat/EMS, Switzerland) and Staphyloid® AC 4030 (an impact and flexibility modifier from Dannick Specialties). In some embodiments, the thermoplastic additive is a copolyester additive.

The powder formulation can comprise an adhesion promoter, e.g., a hybrid carboxy-functional hydroxy-functional metal organic compound or a hydrocarbon resin. In some embodiments, the powder formulation comprises an adhesion promoter (e.g., a hybrid carboxy-functional hydroxy-functional metal organic compound or a hydrocarbon resin) in a total amount of about 0.1 wt % to about 5 wt % of the formulation, e.g., about 0.5 wt % to about 5 wt %, about 1 wt % to about 5 wt %, about 2 wt % to about 5 wt %, about 3 wt % to about 5 wt %, about 4 wt % to about 5 wt %, about 0.1 wt % to about 4 wt %, about 0.1 wt % to about 3 wt %, about 0.1 wt % to about 2 wt %, about 0.1 wt % to about 1 wt %, or about 0.1 wt % to about 0.5 wt % of the formulation.

In some embodiments, the powder formulation comprises one or more adhesion promoters (e.g., any described herein) in a total amount of at least about 0.1 wt % (e.g., at least about 0.2 wt %, at least about 0.5 wt %, at least about 1 wt %, at least about 1.5 wt %, or at least about 2 wt %) and/or at most about 5 wt % (e.g., at most about 4.5 wt %, at most about 4 wt %, at most about 3.5 wt %, at most about 3 wt %, at most about 2.5 wt %, at most about 2 wt %, or at most about 1.5 wt %) of the formulation.

Non-limiting examples for adhesion promoters include Chartsil C523.2H (a hybrid carboxy/hydroxy functional metal organic adhesion promoter absorbed upon a precipitated silica carrier from Chartwell International, Inc., Attleboro Falls, MA), and Teckrez® A89 (an aldehyde hydrocarbon resin from Teckrez, LLC, Jacksonville, FL).

The powder formulation can comprise a co-crosslinker, e.g., any crosslinker or crosslinking agent described herein. In some embodiments, the powder formulation comprises a co-crosslinker in a total amount of about 0.1 wt % to about 5 wt % of the formulation, e.g., about 0.5 wt % to about 5 wt %, about 1 wt % to about 5 wt %, about 2 wt % to about 5 wt %, about 3 wt % to about 5 wt %, about 4 wt % to about 5 wt %, about 0.1 wt % to about 4 wt %, about 0.1 wt % to about 3 wt %, about 0.1 wt % to about 2 wt %, about 0.1 wt % to about 1 wt %, or about 0.1 wt % to about 0.5 wt % of the formulation.

In some embodiments, the powder formulation comprises one or more co-crosslinkers (e.g., any described herein) in a total amount of at least about 0.05 wt % (e.g., at least about 0.1 wt %, at least about 0.2 wt %, at least about 0.3 wt %, at least about 0.4 wt %, at least about 0.5 wt %, at least about 1.0 wt %, at least about 1.5 wt %, at least about 2 wt %, at least about 3 wt %, at least about 4 wt %, at least about 5 wt %, at least about 6 wt %, at least about 7 wt %, at least about 8 wt %, at least about 9 wt %, or at least about 10 wt %) and/or at most about 20 wt % (e.g., at most about 15 wt %, at most about 10 wt %, at most about 9 wt %, at most about 8 wt %, at most about 7 wt %, at most about 6 wt %, at most about 5 wt %, at most about 4 wt %, at most about 3 wt %, at most about 2 wt %, at most about 1 wt %) of the formulation.

Non-limiting examples of co-crosslinkers, crosslinker, or crosslinking agents include an isocyanate (e.g., a polyisocyanate, an isocyanate adduct, an aliphatic polyisocyanate, a cycloaliphatic polyisocyanate), a glycidyl ester (e.g., glycidyl methacrylate, triglycidyl trimellitate, diglycidyl terephthalate), a hydroxyalkylamide (e.g., β-hydroxyalkylamide; or R¹)₂NC(O)-Ak-C(O)N(R¹)₂, as described herein), or a combination of any of these. In some embodiments, the isocyanate comprises an NCO content of about 10 wt % to about 30 wt %.

Yet other non-limiting examples for crosslinking agents include Vestagon® crosslinking agents from Evonik Corp. Parsippany, NJ (e.g., Vestagon® BF 1400, a polyisocyanate adduct; Vestagon® BF 1530, a polyisocyanate adduct, and Vestagon® BF 1540, a polyisocyanate adduct), and Crelan® crosslinking agents (e.g., Crelan® NW-5, a blocked cycloaliphatic polyisocyanate; Crelan® VP LS 2256, a blocked aliphatic polyisocyanate).

The powder formulation can comprise a viscosity modifier. In some embodiments, the powder formulation comprises a viscosity modifier in a total amount of about 1 wt % to about 10 wt % of the formulation, e.g., about 1 wt % to about 5 wt %, about 2 wt % to about 5 wt %, about 3 wt % to about 5 wt %, about 4 wt % to about 5 wt %, about 1 wt % to about 4 wt %, about 1 wt % to about 3 wt %, about 1 wt % to about 2 wt % of the formulation. In some embodiments, the powder formulation comprises a viscosity modifier in a total amount of about 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2.0 wt %, 2.5 wt %, 3 wt %, 3.5 wt %, 4 wt %, 4.5 wt %, or 5 wt % of the formulation. In some embodiments, the powder formulation comprises a viscosity modifier in a total amount of about 0.5 wt. % to about 2 wt. % of the formulation.

In some embodiments, the powder formulation comprises one or more viscosity modifiers (e.g., any described herein) in a total amount of at least about 0.05 wt % (e.g., at least about 0.1 wt %, at least about 0.2 wt %, at least about 0.3 wt %, at least about 0.4 wt %, at least about 0.5 wt %, at least about 1.0 wt %, at least about 1.5 wt %, at least about 2 wt %, at least about 3 wt %, at least about 4 wt %, at least about 5 wt %, at least about 6 wt %, at least about 7 wt %, at least about 8 wt %, at least about 9 wt %, or at least about 10 wt %) and/or at most about 20 wt % (e.g., at most about 15 wt %, at most about 10 wt %, at most about 9 wt %, at most about 8 wt %, at most about 7 wt %, at most about 6 wt %, at most about 5 wt %, at most about 4 wt %, at most about 3 wt %, at most about 2 wt %, at most about 1 wt %) of the formulation.

Non-limiting examples for a viscosity modifier include Teckrez® A89 (an aldehyde resin hydrocarbon resin from Teckrez, LLC, Jacksonville, FL) or Teckrez® A90 (an aldehyde resin hydrocarbon resin from Teckrez, LLC, Jacksonville, FL). Other non-limiting examples of a viscosity modifier include a modified wax (e.g., BYK®-3950 P from BYK-Chemie GmbH, Wesel, Germany) and a castor oil derivative (e.g., Thixicin® E, an organic derivative of castor oil from Elementis, London, UK).

The powder formulation can comprise an antimicrobial agent, e.g., mold and fungi resistance additive and/or antimicrobial agent. In some embodiments, the powder formulation comprises an antimicrobial agent in a total amount of about 0.1 wt % to about 10 wt % of the formulation. In some embodiments, the powder formulation comprises an antimicrobial agent in a total amount of about 1 wt % to about 10 wt % of the formulation, e.g., about 1 wt % to about 2 wt %, about 1 wt % to about 3 wt %, about 1 wt % to about 4 wt %, about 1 wt % to about 5 wt %, about 1 wt % to about 6 wt %, about 1 wt % to about 7 wt %, about 1 wt % to about 8 wt %, about 1 wt % to about 9 wt %, about 2 wt % to about 5 wt %, about 3 wt % to about 5 wt %, about 4 wt % to about 5 wt %, about 1 wt % to about 4 wt %, about 1 wt % to about 3 wt %, about 1 wt % to about 2 wt % of the formulation. In some embodiments, the powder formulation comprises an antimicrobial agent in a total amount of about 1 wt %, 1.5 wt %, 2.0 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, 9 wt %, 9.5 wt %, or 10 wt % of the formulation. In some embodiments, the antimicrobial agent includes elemental silver. In some embodiments, the powder formulation comprises about 0.1 wt % to about 5 wt % of an antimicrobial agent.

In some embodiments, the powder formulation comprises one or more antimicrobial agents (e.g., any described herein) in a total amount of at least about 0.05 wt % (e.g., at least about 0.1 wt %, at least about 0.2 wt %, at least about 0.3 wt %, at least about 0.4 wt %, at least about 0.5 wt %, at least about 1.0 wt %, at least about 1.5 wt %, at least about 2 wt %, at least about 3 wt %, at least about 4 wt %, at least about 5 wt %, at least about 6 wt %, at least about 7 wt %, at least about 8 wt %, at least about 9 wt %, or at least about 10 wt %) and/or at most about 20 wt % (e.g., at most about 15 wt %, at most about 10 wt %, at most about 9 wt %, at most about 8 wt %, at most about 7 wt %, at most about 6 wt %, at most about 5 wt %, at most about 4 wt %, at most about 3 wt %, at most about 2 wt %, at most about 1 wt %) of the formulation.

Non-limiting examples for an antimicrobial agent include IONPURE WPA (a silver glass powder from Ishizuka Glass Co. Ltd., Aichi, Japan) and Fiberbrake® ZB Fine (a zinc borate having a medium particle size of about 2 μm from U.S. Borax, Chicago, IL). In some embodiments, the antimicrobial agent comprises silver, zinc borate, or a combination thereof. The powder formulation can comprise a rheology modifier, e.g., silica (e.g., silane treated silica), clay (e.g., inorganic clay), talc, or other particles. In some embodiments, the powder formulation comprises a rheology modifier (e.g., silica) in a total amount of about 0.05 wt % to about 5 wt % of the formulation, e.g., about 0.1 wt % to about 10 wt %, about 1 wt % to about 10 wt %, about 2.5 wt % to about 10 wt %, about 5 wt % to about 10 wt %, about 7.5 wt % to about 10 wt %, about 0.05 wt % to about 7.5 wt %, about 0.05 wt % to about 5 wt %, about 0.05 wt % to about 2.5 wt %, or about 0.05 wt % to about 1 wt % of the formulation.

In some embodiments, the powder formulation comprises one or more rheology modifiers (e.g., any described herein) in a total amount of at least about 0.05 wt % (e.g., at least about 0.1 wt %, at least about 0.2 wt %, at least about 0.5 wt %, at least about 1 wt %, at least about 1.5 wt %, or at least about 2 wt %) and/or at most about 10 wt % (e.g., at most about 7 wt %, at most about 5 wt %, at most about 4.5 wt %, at most about 4 wt %, at most about 3.5 wt %, at most about 3 wt %, at most about 2.5 wt %, at most about 2 wt %, or at most about 1.5 wt %) of the formulation.

Non-limiting examples for rheology modifiers include Sipernat® 22 S (fine particle silica from Evonik Corp., Parsippany, NJ), and Resiflow® PH-241 (mixture of acrylic polymer and silica from Estron Chemicals, Inc., Calvert City, KY). The powder formulation can comprise a pigment, e.g., an organic pigment (e.g., carbon black), an inorganic pigment (e.g., titanium dioxide), an exterior pigment, or a combination of any of these. In some embodiments, the powder formulation comprises a pigment (e.g., an organic pigment (e.g., carbon black), an inorganic pigment (e.g., titanium dioxide), an exterior pigment, or a combination of any of these) in a total amount of about 0.1 wt % to about 30 wt % of the formulation, e.g., about 2.5 wt % to about 30 wt %, about 5 wt % to about 30 wt %, about 7.5 wt % to about 30 wt %, about 10 wt % to about 30 wt %, about 20 wt % to about 30 wt %, about 25 wt % to about 30 wt %, about 1 wt % to about 25 wt %, about 2.5 wt % to about 25 wt %, about 5 wt % to about 25 wt %, about 7.5 wt % to about 25 wt %, about 10 wt % to about 25 wt %, about 20 wt % to about 25 wt %, about 1 wt % to about 10 wt %, about 2.5 wt % to about 10 wt %, about 5 wt % to about 10 wt %, about 7.5 wt % to about 10 wt %, about 0.1 wt % to about 25 wt %, about 0.1 wt % to about 20 wt %, about 0.1 wt % to about 10 wt %, about 0.1 wt % to about 7.5 wt %, about 0.1 wt % to about 5 wt %, about 0.1 wt % to about 2.5 wt %, about 0.1 wt % to about 1 wt %, about 1 wt % to about 5 wt %, about 5 wt % to about 10 wt %, about 10 wt % to about 15 wt %, about 15 wt % to about 20 wt %, about 25 wt % to about 30 wt %, about 12 wt % to about 20 wt %, about 12 wt % to about 25 wt %, about 12 wt % to about 30 wt %, about 20 wt % to about 25 wt %, about 20 wt % to about 30 wt %, about 1 wt % to about 10 wt %, about 5 wt % to about 15 wt %, about 10 wt % to about 20 wt %, about 15 wt % to about 25 wt %, or about 25 wt % to about 30 wt % of the formulation. The powder formulation can comprise a pigment, e.g., an organic pigment (e.g., carbon black), an inorganic pigment (e.g., titanium dioxide), an exterior pigment, or a combination of any of these. In some embodiments, the powder formulation comprises a pigment (e.g., an organic pigment (e.g., carbon black), an inorganic pigment (e.g., titanium dioxide), an exterior pigment, or a combination of any of these) in a total amount of about 1 wt %, 1.5 wt %, 2 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, 9 wt %, 9.5 wt %, 10 wt %, 10.5 wt %, 11 wt %, 11.5 wt %, 12 wt %, 12.5 wt %, 13 wt %, 13.5 wt %, 14 wt %, 14.5 wt %, 15 wt %, 15.5 wt %, 16 wt %, 16.5 wt %, 17 wt %, 17.5 wt %, 18 wt %, 18.5 wt %, 19 wt %, 19.5 wt %, 20 wt %, 20.5 wt %, 21 wt %, 21.5 wt %, 22 wt %, 22.5 wt %, 23 wt %, 23.5 wt %, 24 wt %, 24.5 wt %, or 25 wt %. In some embodiments, the powder formulation comprises a pigment in a total amount of about 0.1 wt. % to about 35 wt. %, about 15 wt. % to about 25 wt. %, or about 15 wt. % to about 20 wt. % of the formulation. In some embodiments, the pigment includes titanium dioxide (e.g., Ti-Pure™ R-960 supplied by Chemours, Tioxide™ TR93 supplied by Venator Materials, Tiona™ 596 supplied by Tronox, Tronox™ CR-826 supplied by Tronox). In some embodiments, the pigment includes iron oxide yellow colorant (e.g., Colortherm™ 10 supplied by Lanxess). In some embodiments, the pigment includes iron oxide red colorant (e.g., Bayferrox™ 130 BM supplied by Lanxess). In some embodiments, the pigment includes iron oxide black colorant (e.g., Bayferrox™ 303T supplied by Lanxess).

In some embodiments, the powder formulation comprises one or more pigments (e.g., any described herein) in a total amount of at least about 0.05 wt % (e.g., at least about 0.1 wt %, at least about 0.2 wt %, at least about 0.3 wt %, at least about 0.4 wt %, at least about 0.5 wt %, at least about 1.0 wt %, at least about 1.5 wt %, at least about 2 wt %, at least about 3 wt %, at least about 4 wt %, at least about 5 wt %, at least about 6 wt %, at least about 7 wt %, at least about 8 wt %, at least about 9 wt %, or at least about 10 wt %) and/or at most about 30 wt % (e.g., at most about 25 wt %, at most about 20 wt %, at most about 15 wt %, at most about 10 wt %, at most about 9 wt %, at most about 8 wt %, at most about 7 wt %, at most about 6 wt %, at most about 5 wt %, at most about 4 wt %, at most about 3 wt %, at most about 2 wt %, at most about 1 wt %) of the formulation.

In some embodiments, the powder formulation comprises a pigment (e.g., a non-conductive pigment). In some embodiments, the pigment comprises an organic pigment (e.g., carbon black), an inorganic pigment (e.g., titanium dioxide), or a combination thereof.

Non-limiting examples for pigments include Ti-Pure® R-960 (rutile titanium dioxide pigment from DuPont™, Wilmington, DE), Tioxide® TR93 (pigment white from Venator, Wynyard, U.K.), and MONARCH® 1300 (pigment black from Cabot Corp., Billerica, MA).

### Further Additives

The powder formulations herein can include further additives. Non-limiting examples of additives include one or more of the following: fillers, curing catalysts, rheology modifiers, and surfactants (e.g., nonionic, anionic, cationic, or zwitterionic surfactants).

In some embodiments, the additive includes a filler. Non-limiting examples of fillers include aluminum flakes, aluminum oxide, aluminum silicate, alumina trihydrate, sodium aluminum silicate, amphibole, barium sulfate, calcium carbonate, calcium feldspar, calcium metasilicate, ceramic micro spheres, chlorite, cristobalite, diatomaceous earth, feldspar, glass powder, glass beads, ground pumice, kaolin (including metakaolin), kieselguhr, magnesium aluminum silicate, magnesium hydroxide, magnesium silicate, mica, perlite, pyrophyllite, quartz, silica, talcum, titanium dioxide, wollastonite, and zinc oxide, as well as combinations thereof and derivatives thereof (e.g., hydrated forms). The filler can have any useful shape (e.g., acicular, cubical, granular, lamellar, spherical, tabular) or size (e.g., an average particle size of 0.5 microns to 50 microns).

In some embodiments, the powder formulation comprises one or more fillers (e.g., any described herein) in a total amount of about 0.1 wt. % to about 50 wt. %. In some embodiments, the powder formulation comprises one or more fillers (e.g., any described herein) in a total amount of at least about 0.05 wt % (e.g., at least about 0.1 wt %, at least about 0.2 wt %, at least about 0.3 wt %, at least about 0.4 wt %, at least about 0.5 wt %, at least about 1.0 wt %, at least about 1.5 wt %, at least about 2 wt %, at least about 3 wt %, at least about 4 wt %, at least about 5 wt %, at least about 6 wt %, at least about 7 wt %, at least about 8 wt %, at least about 9 wt %, or at least about 10 wt %) and/or at most about 50 wt % (e.g., at most about 40 wt %, at most about 30 wt %, at most about 20 wt %, at most about 15 wt %, at most about 10 wt %, at most about 9 wt %, at most about 8 wt %, at most about 7 wt %, at most about 6 wt %, or at most about 5 wt %) of the formulation.

The powder formulation can comprise one or more curing catalysts, e.g., ammonium compounds (e.g., dodecyltrimethylammonium bromide (DTMAB), benzyltrimethylammonium bromide, or any others described herein, such as an ammonium salt), phosphonium compounds (e.g., ethyl triphenyl phosphonium bromide, or any others described herein, such as a phosphonium salt), Lewis acids (e.g., boron trifluoride, trimethoxy boroxine, or a combination of any of these; or B(R⁴)₃, wherein each R⁴ is, independently, hydrogen (H), halo (e.g., F, Cl, Br, or I), hydroxyl (e.g., OH), an optionally substituted C1-18 hydrocarbyl group (e.g., alkyl, haloalkyl, aryl, alkaryl, aralkyl), or an optionally substituted C1-18 hydrocarbyloxy group (e.g., alkoxy, aryloxy)), tertiary amines (e.g., 1-ethylimidazole, 2-ethylimidazole, octyldimethylamine, N,N-dimethylbenzylamine, dodecyl dimethylbenzylamine, tetramethyl guanidine, choline chloride, or a combination of any of these; or N(R¹)₃, wherein each R¹ is, independently, an optionally substituted C1-18 hydrocarbyl group (e.g., alkyl, haloalkyl, aryl, alkaryl, aralkyl), an optionally substituted imino group (e.g., —CN(R⁵)N(R⁵)₂, each R⁵ is, independently, H or an optionally substituted C1-18 hydrocarbyl group), or two R¹, taken together with the N to which each is attached, form an optionally substituted heterocyclyl), imidazole-based compounds (e.g., 2-methyl imidazole, 2-ethylimidazole, 2-ethyl-4 (5)-methylimidazole, 2-phenylimidazole), or a combination of any of these.

Non-limiting hydrocarbyloxy groups includes-OR groups, in which R is an optionally substituted hydrocarbyl (e.g., any described herein). Non-limiting hydrocarbyloxy groups include alkoxy, alkenyloxy, alkynyloxy, aryloxy, alkaryloxy (e.g., —O—Ar-Ak, in which Ar is a multivalent aryl group and Ak is an alkyl group), aralkyloxy (e.g., —O-Ak-Ar, in which Ak is a multivalent alkyl group and Ar is an aryl group). The hydrocarbyloxy group can be substituted with one or more substituents (e.g., any described herein for hydrocarbyl).

In some embodiments, the powder formulation comprises a curing catalyst in a total amount of about 0.05 wt % to about 5 wt % of the formulation, e.g., about 0.1 wt % to about 10 wt %, about 1 wt % to about 10 wt %, about 2.5 wt % to about 10 wt %, about 5 wt % to about 10 wt %, about 7.5 wt % to about 10 wt %, about 0.05 wt % to about 7.5 wt %, about 0.05 wt % to about 5 wt %, about 0.05 wt % to about 2.5 wt %, or about 0.05 wt % to about 1 wt % of the formulation.

In some embodiments, the powder formulation comprises one or more curing catalysts (e.g., any described herein) in a total amount of at least about 0.05 wt % (e.g., at least about 0.1 wt %, at least about 0.2 wt %, at least about 0.3 wt %, at least about 0.4 wt %, at least about 0.5 wt %, at least about 1.0 wt %, at least about 1.5 wt %, at least about 2 wt %, at least about 3 wt %, at least about 4 wt %, at least about 5 wt %, at least about 6 wt %, at least about 7 wt %, at least about 8 wt %, at least about 9 wt %, or at least about 10 wt %) and/or at most about 10 wt % (e.g., at most about 9 wt %, at most about 8 wt %, at most about 7 wt %, at most about 6 wt %, at most about 5 wt %, or at most about 3 wt %) of the formulation.

For any additive herein, the additive can be provided as a powder, particle, granule, or a free flowing form. In some embodiments, the additive is provided as being adsorbed on a surface of a solid carrier (e.g., a particle such as a microparticle, a granule, a bead such as a microbead).

In some embodiments, the powder formulation includes an antioxidant. In some embodiments, the antioxidant improves color stability. Non-limiting examples of antioxidants include phenolic antioxidants (e.g., Hostanox® O 16 from Clariant AG, Muttenz, Switzerland). In some embodiments, the powder formulation comprises one or more antioxidants in a total amount of about 0.1 wt. % to about 5 wt. %, or about 0.1 wt. % to about 1 wt. %.

In some embodiments, the powder formulation includes a texture additive. In some embodiments, the texture additive helps to provide a cured coating having improved mar and abrasion resistance and/or a writable surface. In some embodiments, the texture additive comprises polytetrafluoroethylene (PFTE) (e.g., Powdertex 61 from Shamrock Technologies, Newark, NJ) or a blend of polytetrafluoroethylene and polyethylene (e.g., TF 1830 from Lanco™ TF 1830 Micronized Wax) or a polymeric, coarse texture additive (e.g., Ceraflour™ 967 supplied by BYK additives). In some embodiments, the texture additive comprises polytetrafluoroethylene, a blend of polytetrafluoroethylene and polyethylene, or a polymeric coarse texture additive. In some embodiments, the texture additive is present in a total amount of about 0.1 wt % to about 30 wt % of the formulation. In some embodiments, the texture additive is present in a total amount of about 1 wt % to about 5 wt % of the formulation.

### Other Formulations

In some embodiments, a powder formulation for a heat sensitive substrate comprises
about 30 wt % to about 90 wt % of an acid functional polyester resin;
about 3 wt % to about 10 wt % of a curing agent, wherein the curing agent comprises triglycidyl isocyanurate;
about 0.1 wt % to about 6 wt % of a phase transfer catalyst, wherein the catalyst comprises benzyltriethylammonium chloride;
about 0.1 wt % to about 5 wt % of a transfer efficiency additive, wherein the transfer efficiency additive comprises barium titanate, a carboxylic acid ester, or a combination thereof;
about 0.1 wt % to about 5 wt % of an antistatic agent, wherein the antistatic agent comprises a hydroxyalkylamide crosslinker, a carboxylic acid ester, or a combination thereof; and
one or both of the following: about 1 wt % to about 30 wt % of a spherical filler, and about 0.1 wt. % to about 40 wt. % of a gloss reducer;
wherein the spherical filler comprises glass microbeads, silica, or a combination thereof; and
the gloss reducer comprises micronized wax, a functionalized epoxy, a blend of polytetrafluoroethylene and polyethylene, a blend of polytetrafluoroethylene and synthetic wax, or a combination thereof.

In some embodiments, a powder formulation for a heat sensitive substrate comprises
about 30 wt % to about 90 wt % of an acid functional polyester resin;
about 3 wt % to about 10 wt % of a curing agent, wherein the curing agent comprises triglycidyl isocyanurate;
about 0.1 wt % to about 6 wt % of a phase transfer catalyst, wherein the catalyst comprises benzyltriethylammonium chloride;
about 0.1 wt % to about 5 wt % of a transfer efficiency additive, wherein the transfer efficiency additive comprises barium titanate, a carboxylic acid ester, or a combination thereof;
about 0.1 wt % to about 5 wt % of an antistatic agent, wherein the antistatic agent comprises a hydroxyalkylamide crosslinker, a carboxylic acid ester, or a combination thereof; and
about 1 wt % to about 30 wt % of a spherical filler, wherein the spherical filler comprises glass microbeads, silica, or a combination thereof.

In some embodiments, a powder formulation for a heat sensitive substrate comprises
about 30 wt % to about 90 wt % of an acid functional polyester resin;
about 3 wt % to about 10 wt % of a curing agent, wherein the curing agent comprises triglycidyl isocyanurate;
about 0.1 wt % to about 6 wt % of a phase transfer catalyst, wherein the catalyst comprises benzyltriethylammonium chloride;
about 0.1 wt % to about 5 wt % of a transfer efficiency additive, wherein the transfer efficiency additive comprises barium titanate, a carboxylic acid ester, or a combination thereof;
about 0.1 wt % to about 5 wt % of an antistatic agent, wherein the antistatic agent comprises a hydroxyalkylamide crosslinker, a carboxylic acid ester, or a combination thereof; and
about 0.1 wt. % to about 40 wt. % of a gloss reducer, wherein the gloss reducer comprises micronized wax, a functionalized epoxy, a blend of polytetrafluoroethylene and polyethylene, a blend of polytetrafluoroethylene and synthetic wax, or a combination thereof.

In some embodiments, a powder formulation for a heat sensitive substrate comprises:
about 40 wt % to about 65 wt % of an acid functional polyester resin;
about 4 wt % to about 10 wt % of a curing agent;
about 0.05 wt % to about 5 wt % of a degassing agent;
about 1 wt % to about 20 wt % of one or more spherical fillers;
about 1 wt % to about 30 wt % of an amorphous metal silicate;
about 0.1 wt % to about 5 wt % of a phase-transfer catalyst;
about 0.1 wt % to about 5 wt % of a flow modifier;
about 0.1 wt % to about 5 wt % of a transfer efficiency additive; and
about 0.1 wt % to about 2 wt % of an antistatic agent.

In some embodiments, the powder formulations disclosed herein further include a pigment, a crystalline resin, a thermoplastic additive, an adhesion promoter, a co-crosslinker a gloss reducer, a viscosity modifier, or an antimicrobial agent, or a combination thereof to provide 100 wt %.

In some embodiments, a powder formulation for a heat sensitive substrate comprises about 30 wt % to about 90 wt % of an acid functional polyester resin; about 3 wt % to about 10 wt % of a curing agent; about 0.05 wt % to about 5 wt % of a degassing agent; about 0.1 wt % to about 6 wt % of a catalyst; about 0.1 wt % to about 5 wt % of a flow modifier; about 0.1 wt % to about 5 wt % of an antistatic agent; and about 0.1 wt % to about 5 wt % of a transfer efficiency additive.

In some embodiments, a powder formulation for a heat sensitive substrate comprises about 40 wt % to about 65 wt % of an acid functional polyester resin (e.g., SP-6491); about 4 wt % to about 10 wt % of a curing agent (e.g., triglycidyl isocyanurate (TGIC)); about 0.05 wt % to about 5 wt % of a degassing agent (e.g., benzoin); about 1 wt % to about 20 wt % of one or more spherical fillers (e.g., Spheriglass 3000E and/or Spherilex DP-015); about 0.1 wt % to about 5 wt % of a phase-transfer catalyst (e.g., tetraalkyl ammonium halide); about 0.1 wt % to about 5 wt % of a flow modifier (e.g., an acrylic polymer); about 0.1 wt % to about 5 wt % of a transfer efficiency additive (e.g., barium titanate); and about 0.1 wt % to about 2 wt % of an antistatic agent (e.g., a hydroxyalkylamide).

In some embodiments, a powder formulation for a heat sensitive substrate comprises about 40 wt % to about 65 wt % of an acid functional polyester resin; about 4 wt % to about 10 wt % of a curing agent (e.g., triglycidyl isocyanurate (TGIC); about 0.05 wt % to about 5 wt % of a degassing agent (e.g., amide modified phenolated urea surfactant); about 1 wt % to about 20 wt % of one or more spherical fillers (e.g., Spheriglass 3000E, Spheriglass 5000E, and/or Spherilex DP-015); about 0.1 wt % to about 5 wt % of a phase-transfer catalyst (e.g., tetraalkyl ammonium halide); about 0.1 wt % to about 5 wt % of a flow modifier (e.g., an acrylic polymer); about 0.1 wt % to about 2 wt % of an antistatic agent (e.g., a carboxylic acid ester), wherein the antistatic agent is a transfer efficiency additive; about 0.1 wt. % to about 5 wt. % of a viscosity modifier (e.g., modified wax or castor oil derivative); and about 0.1 wt. % to about 5 wt. % of a gloss reducer (e.g., micronized wax).

In some embodiments, the powder formulation comprises:

| Component | Use | Range (wt %) |
|---|---|---|
| Acid functional polyester | polyester resin | 0-30 |
| resin (acid value 50) | | |
| Acid functional polyester | polyester resin | 20-55 |
| resin (acid value 33) | | |
| Triglycidyl isocyanurate (TGIC) | curing agent | 3-6 |
| Mixture of acrylic | flow modifier | 0.5-2 |
| polymer and silica | | |
| Modified wax | viscosity modifier | 0-2 |
| Carboxylic acid ester | antistatic agent and | 0-1 |
| | transfer efficiency | |
| | additive | |
| Amide modified phenolated | degassing agent | 0.1-1.0 |
| urea surfactant | | |
| Titanium dioxide | pigment | 15-20 |
| Benzyltriethylammonium | phase-transfer catalyst | 0.3-0.55 |
| chloride | | |
| Micronized wax | gloss reducer | 1-5 |
| Glass microbeads | spherical filler and | 5-10 |
| | gloss reducer | |
| Precipitated silica | spherical filler and | 10-15 |
| | gloss reducer | |
| Castor oil derivative | viscosity modifier | 0-2 |
| Total (wt %) | | 100. |

In some embodiments, the total amount of acid functional polyester resin in the formulation is about 50 wt % to about 55 wt %. In some embodiments, the total amount of viscosity modifier in the formulation is about 0.5 wt. % to about 2 wt. %.

In some embodiments, a powder formulation for a heat sensitive substrate comprises about 40 wt % to about 65 wt % of an acid functional polyester resin; about 4 wt % to about 10 wt % of a curing agent (e.g., triglycidyl isocyanurate (TGIC); about 0.05 wt % to about 5 wt % of a degassing agent (e.g., amide modified phenolated urea surfactant); about 0.1 wt % to about 5 wt % of a phase-transfer catalyst (e.g., tetraalkyl ammonium halide); about 0.1 wt % to about 5 wt % of a flow modifier (e.g., an acrylic polymer); about 0.1 wt % to about 2 wt % of an antistatic agent (e.g., a carboxylic acid ester), wherein the antistatic agent is a transfer efficiency additive; about 0.1 wt. % to about 5 wt. % of a viscosity modifier (e.g., modified wax or castor oil derivative); and optionally:
about 1 wt % to about 20 wt % of one or more spherical fillers (e.g., Spheriglass 3000E, Spheriglass 5000E, and/or Spherilex DP-015);
and about 0.1 wt. % to about 5 wt. % of a gloss reducer (e.g., micronized wax);
about 1 wt. % to about 30 wt. % one or more fillers (e.g., sodium aluminum silicate).

In some embodiments, a powder formulation for a heat sensitive substrate comprises about 30 wt % to about 55 wt % of an acid functional polyester resin, wherein the polyester resin comprises a catalyst; about 0.05 wt % to about 5 wt % of a degassing agent (e.g., amide modified phenolated urea surfactant); about 0.1 wt % to about 5 wt % of a flow modifier (e.g., an acrylic polymer); about 0.1 wt % to about 5 wt % of a transfer efficiency additive (e.g., barium titanate); about 0.1 wt % to about 2 wt % of an antistatic agent (e.g., a carboxylic acid ester); and about 25 wt. % to about 50 wt. % of a gloss reducer (e.g., a functional epoxy resin).

In some embodiments, the powder formulation comprises:

| Component | Use | Range (wt %) |
|---|---|---|
| Acid functional saturated | polyester resin, | 35-40 |
| polyester resin with | catalyst, and curing | |
| dispersed catalyst | agent | |
| Functional epoxy with | gloss reducer | 35-40 |
| EEW 460 | | |
| Mixture of acrylic | flow modifier | 0.5-2 |
| polymer and silica | | |
| Carboxylic acid ester | antistatic agent | 0.1-1.0 |
| Amide modified phenolated | degassing agent | 0.1-1.0 |
| urea surfactant | | |
| Titanium dioxide | pigment | 15-25 |
| Barium titanate | transfer efficiency | 0.1-1.0 |
| | additive | |
| Phenolic antioxidant | antioxidant | 0.1-1.0 |
| Total (wt %) | | 100. |

In some embodiments, a powder formulation for a heat sensitive substrate comprises about 40 wt % to about 90 wt % of an acid functional polyester resin (e.g., SP-6491 or Crylcoat® resin); about 4 wt % to about 10 wt % of a curing agent (e.g., triglycidyl isocyanurate (TGIC)); about 0.05 wt % to about 5 wt % of a degassing agent (e.g., amide modified phenolated urea surfactant); about 0.1 wt % to about 6 wt % of a phase-transfer catalyst (e.g., tetraalkyl ammonium halide); about 0.1 wt % to about 5 wt % of a flow modifier (e.g., an acrylic polymer); about 0.1 wt % to about 2.5 wt % of an antistatic agent (e.g., a carboxylic acid ester), wherein the antistatic agent is a transfer efficiency additive.

In some embodiments, a powder formulation for a heat sensitive substrate comprises:

| Component | Use | Range (wt %) |
|---|---|---|
| Acid functional polyester resin | polyester resin | 40-80 |
| Triglycidyl isocyanurate (TGIC) | curing agent | 4.5-9.0 |
| Benzyltriethylammonium | phase-transfer catalyst | 0.3-0.5 |
| chloride | | |
| Carboxylic acid ester | antistatic agent and | 0.1-1.0 |
| | transfer efficiency | |
| | additive | |
| Blend of polytetrafluoroethylene | Gloss reducer/matting | 0.02-2.0 |
| and polyethylene | agent, abrasion and | |
| | scratch resistant | |
| | additive, texture | |
| | additive | |
| Barium sulfate | filler, hardness | 4-35 |
| | enhancer, surface | |
| | smoothing additive | |
| Colorants (e.g., Titanium | Pigments | 0-40. |
| dioxide) | | |

Also provided herein is a powder formulation for a heat sensitive substrate, comprising: an acid functional polyester resin; a curing agent; a degassing agent; a catalyst; a transfer efficiency additive; an antistatic agent; and one or more of the following: a degassing agent, a flow modifier, a spherical filler, an amorphous metal silicate, a crystalline resin, a thermoplastic additive, an adhesion promoter, a co-crosslinker, and a gloss reducer.

In some embodiments, the powder formulation for a heat sensitive substrate comprising an acid functional polyester resin, a curing agent, a catalyst (e.g., a phase transfer catalyst), an antistatic agent, a transfer efficiency additive, and optionally one or more of a texture additive, a gloss reducer, and a filler. In some embodiments, the antistatic agent is a transfer efficiency additive.

In some embodiments, the powder formulation is free of one or more components, e.g., a resin, a curing agent, a degassing agent, a spherical filler, a phase-transfer catalyst, a flow modifier, a transfer efficiency additive, an antistatic agent, a conductive agent, a wetting agent, an antioxidant, a pigment, a crosslinking agent, a corrosion resistance filler, an adhesion promoter, a rheology modifier, or a combination of any of these. For example and without limitation, the powder formulation can be free of a bisphenol A (BPA)-containing resin. For example and without limitation, the powder formulation can be free of a polyester resin (e.g., a carboxyl functional polyester resin, a hydroxyl functional polyester resin, an acid functional polyester resin, or combinations thereof). For example and without limitation, the powder formulation can be free of an epoxy resin (e.g., a carboxyl functional epoxy resin, a hydroxyl functional epoxy resin, an acid functional epoxy resin, or combinations thereof). For example and without limitation, the powder formulation can be free of an acrylic resin (e.g., a carboxyl functional acrylic resin, a hydroxyl functional acrylic resin, an acid functional acrylic resin, or combinations thereof). For example and without limitation, the powder formulation can be free of an acid-containing curing agent. For example and without limitation, the powder formulation can be free of a diacid-containing curing agent. For example and without limitation, the powder formulation can be free of a dicyandiamide-containing curing agent. For example and without limitation, the powder formulation can be free of a cyanamide-containing curing agent. For example and without limitation, the powder formulation can be free of a diamide-containing curing agent. For example and without limitation, the powder formulation can be free of a hydroxyalkylamide-containing curing agent. For example and without limitation, the powder formulation can be free of a benzoin-containing degassing agent. For example and without limitation, the powder formulation can be free of an acrylic acid- or acrylate-containing flow modifier. For example and without limitation, the powder formulation can be free of a transfer efficiency additive. For example and without limitation, the powder formulation can be free of a phase-transfer catalyst. For example and without limitation, the powder formulation can be free of an ammonium-containing phase-transfer catalyst. For example and without limitation, the powder formulation can be free of a phosphonium-containing phase-transfer catalyst. For example and without limitation, the powder formulation can be free of an antistatic agent. For example and without limitation, the powder formulation can be free of a conductive agent. For example and without limitation, the powder formulation can be free of a wetting agent. For example and without limitation, the powder formulation can be free of an antioxidant. For example and without limitation, the powder formulation can be free of a conductive pigment. For example and without limitation, the powder formulation can be free of a lead-containing pigment. For example and without limitation, the powder formulation can be free of a crosslinking agent. For example and without limitation, the powder formulation can be free of a hydroxyalkylamide-containing crosslinking agent. For example and without limitation, the powder formulation can be free of an adhesion promoter. For example and without limitation, the powder formulation can be free of a rheology modifier. For any component herein, the component can be provided as a powder, particle, granule, or a free flowing form. In some embodiments, the component is provided as being adsorbed on a surface of a solid carrier (e.g., a particle such as a microparticle, a granule, a bead such as a microbead, a pellet). In some embodiments, the powder formulation and/or coating formed therefrom is free of a poly(urethane), a poly(ureaurethane), or both.

### Non-Limiting Characteristics

In some embodiments, the powder formulation has an average particle size of about 20 to about 50 microns, e.g., about 20 to about 40 microns, about 20 to about 30 microns, about 25 to about 50 microns, about 25 to about 40 microns, or about 30 to about 50 microns.

In some embodiments, the powder formulation is characterized by its flow property (e.g., pill flow). Flow may be determined in any manner, such as described herein. In some embodiments, flow is determined in accordance with ASTM test method D4242, which provides flow characteristics of a fused thermosetting coating powder (e.g., as a pellet) down an inclined plane (e.g., inclined at 65±1° to the horizontal) at a recommended cure temperature for a testing time period. In some embodiments, inclined plane is inclined at 45° to the horizontal. The testing time period can include any useful time period to obtain a total length of flow for the fused thermosetting coating powder down the included plane. In some embodiments, the time period is at least about 1 minute (e.g., at least about 5 minutes or at least about 10 minutes) to at most about 15 minutes. In some embodiments, the recommended cure temperature is any temperature to sufficiently chemically crosslink a powder formulation to provide one or more coating properties. Non-limiting coating properties can include any described herein (e.g., outgassing, edge coverage). Non-limiting cure temperatures can include from about 260° F. to about 300° F. In some embodiments, the cure temperature depends on the type of substrate and ranges from 275° F. to 325° F., measured at the board surface. In some embodiments, flow is determined for a fused thermosetting coating powder (e.g., as a pellet having a dimension of about 12.5±0.05 mm in diameter and about 6.5±0.2 mm in thickness) down an inclined plane (e.g., inclined at 65±1° to the horizontal) at a recommended cure temperature (e.g., 265° F.) for a testing time period (e.g., at least 10 minutes, such as about 10 minutes or about 15 minutes). In some embodiments, the flow is measured on a metal substrate.

In some embodiments, the powder formulation has a flow of about 13 to about 80 mm at 265° F. (e.g., down an inclined plane that is inclined at 65±1° to the horizontal and for a testing time period that is at least 10 minutes, such as about 10 minutes or about 15 minutes). In some embodiments, the powder formulation has a flow of about 13 to about 60 mm at 275° F. (e.g., down an inclined plane that is inclined at 65±1° to the horizontal and for a testing time period that is at least 10 minutes, such as about 10 minutes or about 15 minutes). In some embodiments, the powder formulation has a flow of about 13 to about 60 mm at 275° F. as measured on a metal substrate.

In some embodiments, the powder formulation has a flow of at least about 13 mm (e.g., at least about 15 mm, at least about 20 mm, at least about 25 mm, at least about 30 mm, at least about 35 mm, at least about 40 mm, at least about 45 mm, at least about 50 mm, at least about 55 mm, or at least about 60 mm) to at most about 80 mm (e.g., at most about 45 mm, at most about 50 mm, at most about 55 mm, at most about 60 mm, at most about 65 mm, at most about 70 mm, or at most about 75 mm) at 265° F. (e.g., down an inclined plane that is inclined at 65±1° to the horizontal and for a testing time period that is at least 10 minutes, such as about 10 minutes or about 15 minutes). Flow may be determined at other temperatures. In some embodiments, the powder formulation has a flow at 174° C. of about 20 mm to about 70 mm, about 30 mm to about 60 mm, or about 40 mm to about 50 mm.

Edge coverage may be determined in any manner, such as described herein. In some embodiments, edge coverage is determined in accordance with ASTM test method D2967-96 or ASTM test method B117, which provides the degree of edge coverage of powder coatings. In some embodiments, such edge coverage (e.g., as determined by average thickness of the powder coating at an edge of the coating, such as at a sharp edge measured at a certain angle to the flat surfaces) is compared to face coverage (e.g., as determined by average thickness of the powder coating on a generally flat or planar surface). In some embodiments, the sharp edge includes a 90°, 60°, 45°, or 30°. Measurements for thickness can be at any useful angle to a flat surface (e.g., at an angle of 30°, 45°, 60°, 90°). In some embodiments, the powder formulation is characterized by an edge coverage of at least 12%, at least 13%, at least 14%, at least 15%, at least 16%, at least 17%, at least 18%, at least 19%, at least 20%, at least 21%, at least 22%, at least 23%, at least 24%, at least 25%, or more.

Corner coverage may be determined in any manner, such as described herein. In some embodiments, corner coverage is determined in accordance with ASTM test method D2967-07, which provides the degree of corner coverage of powder coatings. In some embodiments, such corner coverage (e.g., as determined by average thickness of the powder coating at a corner, such as at a sharp corner measured at a certain angle to the flat surfaces) is compared to face coverage (e.g., as determined by average thickness of the powder coating on a generally flat or planar surface). In some embodiments, the sharp corner includes a corner at 90°, 60°, 45°, or 30°. Measurements for thickness can be at any useful angle to a flat surface (e.g., at an angle of 30°, 45°, 60°, 90°). In some embodiments, the powder formulation is characterized by a corner coverage of at least 12%, at least 13%, at least 14%, at least 15%, at least 16%, at least 17%, at least 18%, at least 19%, at least 20%, at least 21%, at least 22%, at least 23%, at least 24%, at least 25%, or more. In some embodiments, a surface of a substrate includes a weld, a seam, or other feature disposed thereon. The feature, itself, may be characterized by a surface and an edge. The extent of coverage for any edge or surface of the feature can be determined in any useful manner. Coverage can be determined for the feature itself (e.g., an edge and/or surface of the feature) or a substrate having a feature disposed thereon (e.g., a substrate having a certain number or types of features, in which coverage can be determined for a portion of the substrate including at least a portion of the feature, a portion of the substrate including the entirety of the feature, or the entirety of the substrate).

Transfer efficiency, which is the ratio of the amount of powder deposited on the substrate to the amount of powder applied to the substrate, may be determined in any manner, such as described herein. In some embodiments, the amount is determined as a weight of the powder, and the ratio is expressed as a percentage. In some embodiments, transfer efficiency is determined in accordance with ASTM test method D5286-20, which provides transfer efficiency under general production conditions for spray application of paints, or with ASTM test method D5066, which provides transfer efficiency under production conditions for spray application of automotive paints using a weight method. In some embodiments, the powder formulation is characterized by a transfer efficiency of at least 60%, at least 65%, at least 70%, at least 75%, at least 80%, at least 85%, at least 90%, at least 95%, at least 96%, at least 97%, at least 98%, at least 99%, or more.

In some embodiments, transfer efficiency is supplemented by comparing measurements regarding powder that applied to the substrate and that ultimately is provided within the cured coating. Without wishing to be limited by mechanism, the amount of powder deposited on a substrate may change during the deposition period. For example and without limitation, powder may fall away from the surface of the substrate during extended deposition periods. Thus, in some embodiments, thickness of the powder formulation (prior to curing and after deposition) is compared to thickness of the cured coating. In other embodiments, an amount (or weight) of the powder formulation (prior to curing and after deposition) is compared to an amount (or weight) of the cured coating.

Thickness of the applied powder formulation in the pre-cured state may be determined in any manner, such as described herein. In some embodiments, thickness of the applied powder formulation in the pre-cured state is determined in accordance with ASTM test method D7378-16, which predicts cured thickness based on measurement of thickness of the applied powder. In some embodiments, the applied powder formulation in the pre-cured state is characterized by a thickness of about 50 to about 200 microns.

In some embodiments, the thickness of the applied powder formulation in the pre-cured state remains substantially similar over a given period of time, e.g., a lag in production when the applied powder formulation is waiting to be cured. In some embodiments, the thickness of the applied powder formulation in the pre-cured state remains substantially similar for about 10 minutes, about 15 minutes, about 20 minutes, about 25 minutes, about 30 minutes, about 35 minutes, about 40 minutes, about 45 minutes, about 50 minutes, about 55 minutes, about 60 minutes, or more.

Cured thickness, which is the thickness of the cured coating, may be determined in any manner, such as described herein. In some embodiments, cured thickness may be determined in accordance with ASTM test method D7378-16, which predicts cured thickness based on measurement of thickness of the applied powder. In some embodiments, the powder formulation is characterized by a cured thickness of about 50 to about 200 microns.

In some embodiments, dry film thickness (“DFT”) refers to the thickness of a dry coating layer, measured using a film thickness gauge using ASTM D6132 or D7091. It is typically expressed in mils (thousandths of an inch) or microns (micrometers).

Gloss consistency, which measures gloss values over the surface of the cured coating, may be determined in any manner, such as described herein. In some embodiments, gloss is determined in accordance with ASTM test method D523, which provides a standard test method for specular gloss. In some embodiments, gloss is measured at 20° and 60° angles using a gloss meter as per ASTM D523. The result is a numerical value without units, often described as “gloss units (GU).” For instance, a reading might be stated as 20 units at 60 degrees. The 20° angle measures high-gloss surfaces, while the 60° angle is for matte to medium-gloss surfaces.

Color differences may be determined in any manner, such as described herein. In some embodiments, color differences are determined in accordance with ASTM test method D2244, which provides a method for calculating color differences from instrumentally measured color coordinates. In some embodiments, the cured coating formed from the powder formulation is characterized by color values of less than 20% variation, e.g., less than 15% variation, less than 10% variation, less than 5% variation, or less than 2% variation.

Bleed through may be determined in any manner, such as described herein. In some embodiments, extent of bleed through is determined by gloss consistency, gloss reduction, color difference measurements, and/or appearance of the primer in the topcoat, e.g., appearance of the primer as specks or flakes in the topcoat.

In some embodiments, the coatings described herein are substantially free of visible defects selected from the group consisting of cracking, swelling, blistering, bubbling, surface irregularities, outgassing, and combinations thereof.

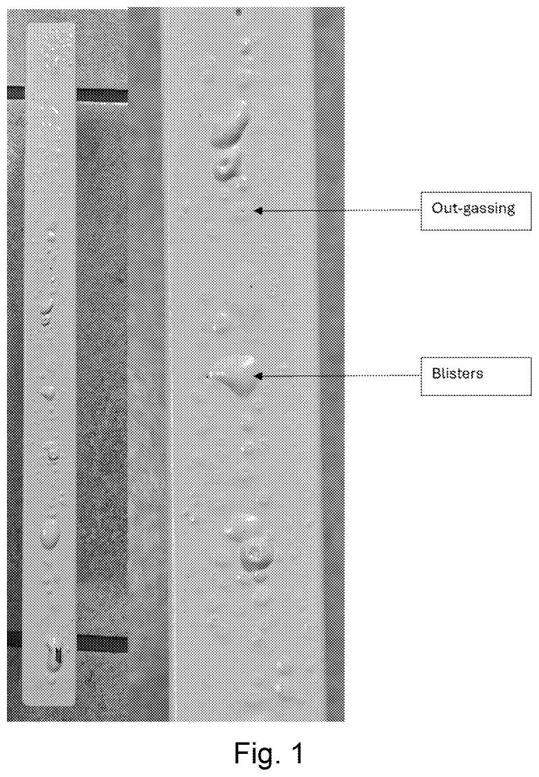

In some embodiments, the coating has improved outgassing during cure. Gassing defects may be determined in any manner, such as described herein. In some embodiments, gassing defects are determined by visual inspection of the cured coating. In some embodiments, the cured coating formed from the powder formulation is characterized as having a continuous cured coating that is substantially free of visible gassing defects, e.g., visible gassing defects such as pinholes, blisters, micro-wrinkles, micro-pores, gloss defects, or a combination of any of these. In some embodiments, visible defects are determined by assessing a surface profile of the coating. FIG. 1 shows examples of visible gassing defects, including blistering and outgassing.

In some embodiments, the coatings described herein have flexibility under humid conditions. In some embodiments, the coating is substantially free of visible defects (e.g., cracking) according to the criteria outlined in the Hinge Hole Test.

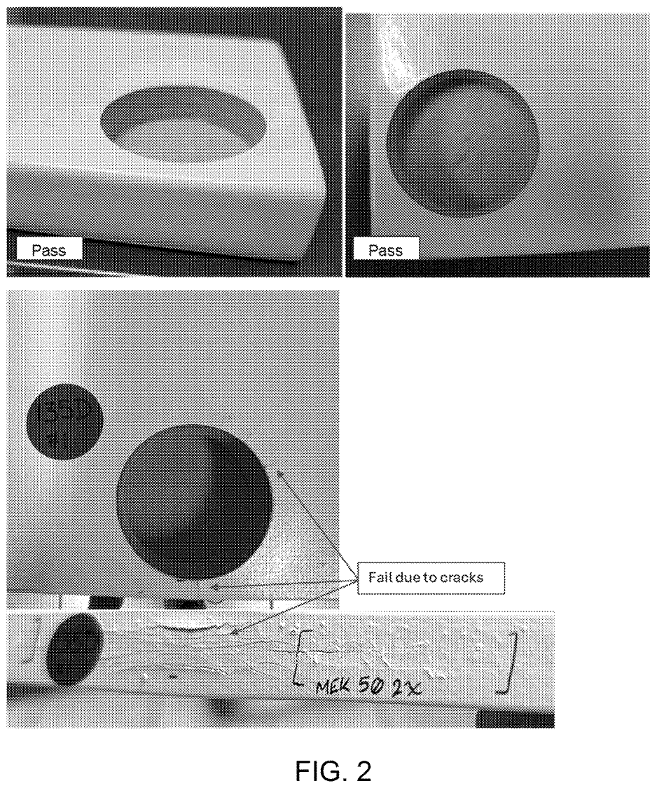

In some embodiments, the Hinge Hole Test comprises creating a hole in a coated substrate (e.g., medium-density fiberboard comprising a coating prepared from a powder formulation described herein) using a drill bit with a diameter of 30-35 mm at a distance of 5±1 mm from the edge. The hole is drilled until approximately 5±1 mm of the substrate thickness remains. Dust and debris are removed from the hole. The hole is filled completely with deionized water, and refilled as needed to maintain water level for 24 hours. The sample is stored at room temperature under normal humidity conditions. At 24 hours, the coating is inspected visually near the hole's edge for any signs of cracking or blistering. FIG. 2 shows examples of Hinge Hole Tests performed on coated substrates. As shown in FIG. 2, the coatings that pass the Hinge Hole Test do not show any visible signs of cracking or blistering. Coatings that fail the Hinge Hole Test show cracks in the coating. In some embodiments, the coatings described herein pass the Hinge Hole Test.

In some embodiments, the coatings described herein are water permeable. In some embodiments, the coating absorbs water but shows no signs of blistering or cracking. For typical coatings, prolonged exposure to moisture can cause the substrate to swell, warp, crack, or develop mold that leads to the decay of substrate (e.g., wood composites). In some embodiments, the powder formulations provided herein provide coatings that allow water vapor to pass through the coating, enabling moisture to escape freely and preventing buildup within the coating.

In some embodiments, the coatings described herein provide resistance to exterior weathering. In some embodiments, the coating has a gloss retention of at least 30% and a color difference ΔE of less than 5 units using ASTM G154 Cycle 1.

In some embodiments, the coatings described herein provide uniform integrity. In some embodiments, the formulations provided herein enable substantially complete cross-linking in a short time at low temperature, providing uniform film integrity from the surface to the base of the coating. In some embodiments, the uniform integrity of the coating provides enhanced aesthetics of composite wood surfaces, making them more visually appealing and presentable.

In some embodiments, the coatings described herein provide good heat distribution. When temperatures drop and humidity decreases, substrates (e.g., wood composite) can release accumulated moisture and contract in size. When temperatures rise and humidity increases, substrates (e.g., wood composite) can absorb moisture from the environment, causing the substrate to swell. In some embodiments, the powder formulations provided herein utilize comprise inorganic pigments (e.g., mixed metal oxide pigments) that can reflect solar radiation and reduce heat buildup, thereby controlling humidity levels, prevent localized over-heating, and promote heat distribution.

Further non-limiting characteristics include film thickness, surface smoothness (e.g., PCI scale of 4 to 8, which may be determined in any manner, such as in accordance with ASTM test method D523), water adsorption (e.g., such as in accordance with ASTM test method D5795), scratch resistance (e.g., from about 3000 to about 9000 μN), abrasion resistance (e.g., which may be determined in any manner, such as by using a Taber abraser in accordance with ASTM test method D4060), mar resistance (e.g., which may be determined in any manner, such as in accordance with ASTM test method D5178), impact resistance (e.g., which may be determined in any manner, such as in accordance with ASTM test method D2794), crosshatch adhesion (e.g., from 4B to 5B), tape adhesion (e.g., which may be determined in any manner, such as in accordance with ASTM test method D3359), hardness (e.g., H to 5H, which may be determined in any manner, such as by using a pencil test in accordance with ASTM test method D3363 or by using a Knoop indentation test in accordance with ASTM test method D1474), gloss (e.g., 0.5 to 50 at 60 angle for a matte coating; or 1 to 99 at 60 angle for a glossy coating, which may be determined in any manner, such as in accordance with ASTM test method D523), crack rating (e.g., which may be determined in any manner, such as for a coated edge of a substrate in accordance with ASTM test methods D661 and/or D2065), for the coating.

In some embodiments, PCI Smoothness is an evaluative comparison of a coating's smoothness against standardized panels provided by Powder Coating Institute (PCI). This method ensures consistent and objective smoothness assessments.

In some embodiments, the gel time of the powder formulation is measured according to ASTM D4217. Gel time refers to the time that it takes for a powder to remain in a liquid state at an elevated temperature (e.g., the time it takes for a molten powder on a hot plate convert from a liquid state to a gel-like or solid state). A gel time of a powder formulation can vary with temperature, e.g., increases at temperatures below 350° F. and decreases at higher temperatures such as 400° F.

In some embodiments, the powder formulation has a gel time at 400° F. of about 5 seconds to about 60 seconds, about 5 seconds to about 40 seconds, about 10 seconds to about 30 seconds, or about 10 seconds to about 20 seconds. In some embodiments, the powder formulation has a gel time at 400° F. of less than 60 seconds, less than 50 seconds, less than 40 seconds, less than 30 seconds, or less than 20 seconds.

In some embodiments, the powder formulation has a gel time at 350° F. of about 30 seconds to about 90 seconds, about 30 seconds to about 80 seconds, about 30 seconds to about 60 seconds, about 30 seconds to about 45 seconds, about 40 seconds to about 60 seconds, or about 40 seconds to about 50 seconds. In some embodiments, the powder formulation has a gel time at 350° F. of less than 90 seconds, less than 80 seconds, less than 70 seconds, less than 60 seconds, less than 55 seconds, less than 50 seconds, or less than 45 seconds. In some embodiments, the powder formulation has a gel time at 350° F. of about 30 seconds to about 80 seconds.

In some embodiments, the powder formulation has a gel time at 300° F. of about 15 seconds to about 150 seconds, about 100 seconds to about 150 seconds, about 15 seconds to about 140 seconds, or about 20 seconds to about 125 seconds. In some embodiments, the powder formulation has a gel time at 400° F. of less than 200 seconds, less than 150 seconds, less than 140 seconds, less than 130 seconds, or less than 120 seconds.

In some embodiments, the coatings described herein have one or more of the following characteristics:
a cross-hatch adhesion of 4B to 5B using ASTM D3359;
a gloss retention of at least 30% and a color difference ΔE of less than 5 units according to ASTM G154 Cycle 1;
a gel time of about 30 seconds to about 80 seconds at 350° F. using ASTM D4217; and
a flow of about 13 mm to about 60 mm at 275° F. using ASTM test method D4242; and
the coating is substantially free of visible defects selected from the group consisting of cracking, swelling, blistering, bubbling, surface irregularities, outgassing, and combinations thereof.

### Substrates and Coated Substrates

The powder formulations described herein can be applied to any suitable substrate. In some embodiments, the substrate is applied to a heat sensitive substrate.

In some embodiments, the present disclosure provides a powder coated substrate comprising: a heat sensitive substrate; and a cured coating disposed on at least a portion of a surface of the heat sensitive substrate, wherein the cured coating comprises the powder formulation of any of the combinations of embodiments above or a cured form thereof.

In some embodiments, the heat sensitive substrate comprises a moisture content from about 2% to about 13%, e.g. about 2% to about 12%, about 2% to about 11%, about 2% to about 10%, about 2% to about 9%, about 2% to about 8%, about 2% to about 7%, about 2% to about 6%, about 2% to about 5%, about 2% to about 4%, about 2% to about 3%, about 2% to about 5%, about 3% to about 6%, about 4% to about 7%, about 5% to about 8%, about 6% to about 9%, about 7% to about 10%, about 8% to about 11%, or about 9% to about 12%.

In some embodiments, the heat sensitive substrate comprises a non-metal substrate. In some embodiments, the substrate is not electrically conductive. In some embodiments, the heat sensitive substrate comprises an oriented strand board, fiber-cement siding, engineered cement board, wood, fiberglass board, particle board, medium-density fiberboard, or high-density fiberboard. In some embodiments, the heat sensitive substrate comprises a wood composite (e.g., oriented strand board, medium-density fiberboard, high-density fiberboard, particle board).

In some embodiments, the cured coating has a dry coating thickness between about 50 microns and about 1 mm. In some embodiments, the cured coating has a surface smoothness on the Powder Coating Institute (PCI) scale of at least 4. In some embodiments, the cured coating has a surface smoothness on the PCI scale of at least 5. In some embodiments, the cured coating has a surface smoothness on the PCI scale of at least 6. In some embodiments, the cured coating has a scratch resistance between 3000 and 9000 μN. In some embodiments, the cured coating has a crosshatch adhesion of 4B to 5B.

In some embodiments, the cured coating comprises a single coating layer (i.e., is prepared from one powder coating composition).

### Methods

In some embodiments, the present disclosure provides a method of applying a powder formulation to a heat sensitive substrate comprising: pre-heating the heat sensitive substrate to a first temperature; applying a powder formulation (e.g., any described herein) to the heat sensitive substrate to form a coat on at least a portion of a surface of the heat sensitive substrate; and heating the heat sensitive substrate with the coat applied thereon to a second temperature, thereby forming a cured coating on at least a portion of the surface of the heat sensitive substrate.

In some embodiments, the heat sensitive substrate comprises a non-metal substrate. In some embodiments, the heat sensitive substrate comprises an oriented strand board, fiber-cement siding, engineered cement board, wood, fiberglass board, particle board, medium-density fiberboard, or high-density fiberboard. In some embodiments, the heat sensitive substrate comprises plastic.

In some embodiments, pre-heating the heat sensitive substrate comprises pre-heating the heat sensitive substrate to a first temperature of about 80° F. to about 300° F. In some embodiments, the pre-heating the heat sensitive substrate comprises pre-heating the heat sensitive substrate to a first temperature of about 100° F. to about 300° F. In some embodiments, the first temperature is in the range of about 80° F. to about 300° F., about 90° F. to about 300° F., about 100° F. to about 300° F., about 110° F. to about 300° F., about 120° F. to about 300° F., about 130° F. to about 300° F., about 140° F. to about 300° F., about 150° F. to about 300° F., about 160° F. to about 300° F., about 170° F. to about 300° F., about 180° F. to about 300° F., about 190° F. to about 300° F., or about 200° F. to about 300° F.

In some embodiments, heating the heat sensitive substrate comprises heating the heat sensitive substrate to a second temperature of about 200° F. to about 350° F. In some embodiments, heating the heat sensitive substrate comprises heating the heat sensitive substrate to a second temperature of about 255° F. to about 300° F. In some embodiments, heating the heat sensitive substrate comprises heating the heat sensitive substrate to a second temperature of about 270° F. to about 290° F. In some embodiments, the second temperature is in the range of about 260° F. to about 300° F., about 265° F. to about 300° F., about 270° F. to about 300° F., about 275° F. to about 300° F., about 280° F. to about 300° F., about 285° F. to about 300° F., about 290° F. to about 300° F., or about 295° F. to about 300° F. In some embodiments, the second temperature is in the range of about 235° F. to about 300° F.

In some embodiments, heating the heat sensitive substrate comprises heating the heat sensitive substrate for between about 1 and about 20 minutes. In some embodiments, heating the heat sensitive substrate comprises heating the heat sensitive substrate for between about 6 and about 18 minutes.

Heat can be provided in any useful manner. In some embodiments, heating includes providing the heat sensitive substrate with a heat source from an infrared (IR) source, a convention heat source, a catalytic IR source, or a combination of any of these. In some embodiments, the heat source is a catalytic IR source.

In some embodiments, the methods disclosed herein further comprise preparing the powder formulation. In some embodiments, preparing the powder formulation comprises mixing the components (e.g., the acid functional polyester resin, curing agent, catalyst, transfer efficiency additive, antistatic agent, and other components as described herein). In some embodiments, the acid functional polyester resin is pre-catalyzed (i.e., the catalyst is already dispersed in the resin prior to mixing with the other components). In some embodiments, the mixing is carried out at a temperature above the softening temperature of the acid functional polyester resin, wherein the temperature is below the curing temperature of the acid functional polyester resin. In some embodiments, the mixing is carried out in an extruder. In some embodiments, preparing the powder formulation further comprises cooling the mixture to solidify, and pulverizing the mixture into a powder.

Other features and advantages of the disclosure will be apparent from the following detailed description, and from the claims.

### EXAMPLES

In order that the disclosure described may be more fully understood, the following examples are set forth. The examples described in this application are offered to illustrate the formulations and the methods provided herein and are not to be construed in any way as limiting their scope.

### Example 1: Preparation of Non-limiting Powder Formulations

The powder formulations herein were prepared by mixing the components in an extruder at a temperature above the softening temperature of the resin but below the curing temperature. The formulations were then extruded and cooled to solidify and then pulverized into a powder. A dry flow additive (e.g., aluminum oxide, silica, or any other herein) was added to the formulations during pulverization.

Non-limiting examples of powder formulations are provided in Tables 1-3.

### Example 2: Non-limiting Powder Formulation

Powder formulations for application to a heat sensitive substrate (e.g., OSB) were prepared as described in Example 1. A non-limiting example of such powder formulations are provided in Table 1.

TABLE 1
Non-limiting example of powder formulations

| | | Range |
|---|---|---|
| Component | Use | (wt %) |
| Acid functional polyester | polyester resin | 45-89 |
| resin (acid value >40) | | |
| Carboxylated polyester resin | crystalline resin | 2.5-15 |
| Triglycidyl isocyanurate (TGIC) | curing agent | 5-10 |
| Copolyester additive | thermoplastic additive | 1-3 |
| Glass microbeads | spherical filler | 0-30 |
| Pumice | amorphous metal silicate | 0-30 |
| Aldehyde hydrocarbon resin | resin | 0-10 |
| Mixture of acrylic | flow modifier | 0.5-2 |
| polymer and silica | | |
| Benzoin | degassing agent | 0.1-1.0 |
| Titanium dioxide | pigment | 0-35 |
| Barium titanate | transfer efficiency additive | 0.3-5 |
| Hydroxyalkylamide | antistatic agent/crosslinker | 0-8 |
| crosslinker | | |
| Benzyltriethylammonium | phase-transfer catalyst | 0.3-0.55 |
| chloride | | |
| Zinc borate-containing | antimicrobial agent | 0-10 |
| powder | | |
| Silver-containing powder | antimicrobial agent | 0-0.4 |
| Total (wt %) | | 100 |

### Example 3: Non-limiting Powder Formulation

Powder formulations for application to a heat sensitive substrate (e.g., MDF) were prepared as described in Example 1. A non-limiting example of such powder formulations are provided in Table 2.

TABLE 2
Non-limiting example of powder formulations

| | | Range |
|---|---|---|
| Component | Use | (wt %) |
| Acid functional polyester | polyester resin | 45-89 |
| resin (acid value >40) | | |
| Triglycidyl isocyanurate (TGIC) | curing agent | 5-10 |
| Copolyester additive | thermoplastic additive | 0.5-3 |
| Glass microbeads | spherical filler | 0-30 |
| Pumice | amorphous metal silicate | 0-30 |
| Aldehyde hydrocarbon resin | resin | 0-10 |
| Mixture of acrylic | flow modifier | 0.5-2 |
| polymer and silica | | |
| Benzoin | degassing agent | 0.1-1 |
| Titanium dioxide | pigment | 0-35 |
| Barium titanate | transfer efficiency additive | 0.3-5 |
| Hydroxyalkylamide | antistatic agent/crosslinker | 0-8 |
| crosslinker | | |
| Benzyltriethylammonium | phase-transfer catalyst | 0.3-0.55 |
| chloride | | |
| Total (wt %) | | 100 |

### Example 4: Non-limiting Powder Formulation

Powder formulations for application to a heat sensitive substrate (e.g., fiberglass) were prepared as described in Example 1. A non-limiting example of such powder formulations are provided in Table 3.

TABLE 3
Non-limiting example of powder formulations

| | | Range |
|---|---|---|
| Component | Use | (wt %) |
| Acid functional polyester | polyester resin | 45-89 |
| resin (acid value >40) | | |
| Triglycidyl isocyanurate (TGIC) | curing agent | 5-10 |
| Copolyester additive | thermoplastic additive | 0-3 |
| Glass microbeads | spherical filler | 0-30 |
| Silica microbeads | spherical filler | 0-30 |
| Pumice | amorphous metal silicate | 0-30 |
| Mixture of acrylic | flow modifier | 0.5-2 |
| polymer and silica | | |
| Benzoin | degassing agent | 0.1-1 |
| Titanium dioxide | pigment | 0-35 |
| Barium titanate | transfer efficiency additive | 0.3-5 |
| Hydroxyalkylamide | antistatic agent/crosslinker | 0-8 |
| crosslinker | | |
| Benzyltriethylammonium | phase-transfer catalyst | 0.3-0.55 |
| chloride | | |
| Micronized wax | gloss reducer | 0-7 |
| Metal organic adhesion | adhesion promoter | 0-30 |
| promoter | | |
| Total (wt %) | | 100 |

### Example 5: Powder Formulations

Specific examples of powder formulations (Examples 5-1, 5-2, 5-3, 5-4, and 5-5) for application to a heat-sensitive substrate (e.g., MDF, particle board) prepared according to Example 1 are provided in Table 4.

TABLE 4
Powder formulations

| | | Ex. 5-1 | Ex. 5-2 | Ex. 5-3 | Ex. 5-4 | Ex. 5-5 |
|---|---|---|---|---|---|---|
| Component | Use | Wt % | Wt % | Wt % | Wt % | Wt % |
| Acid functional polyester | polyester resin | 25.8 | 25.8 | 0 | 0 | 0 |
| resin (acid value 50) | | | | | | |
| Acid functional polyester | polyester resin | 25.8 | 25.8 | 52.6 | 52.6 | 52.6 |
| resin (acid value 33) | | | | | | |
| Triglycidyl isocyanurate | curing agent | 4.9 | 4.9 | 3.9 | 3.9 | 3.9 |
| (TGIC) | | | | | | |
| Mixture of acrylic | flow modifier | 1.0 | 1.0 | 1.0 | 1.0 | 1.0 |
| polymer and silica | | | | | | |
| Modified wax | viscosity | 1.5 | 1.5 | 1.5 | 0.75 | 0 |
| | modifier | | | | | |
| Carboxylic acid ester | antistatic agent | 0 | 0 | 0 | 0.75 | 0.5 |
| | and transfer | | | | | |
| | efficiency | | | | | |
| | additive | | | | | |
| Amide modified | degassing | 0.5 | 0.5 | 0.5 | 0.5 | 0.5 |
| phenolated urea | agent | | | | | |
| surfactant | | | | | | |
| Titanium dioxide | pigment | 17 | 17 | 17 | 17 | 17 |
| Benzyltriethylammonium | phase-transfer | 0.45 | 0.45 | 0.45 | 0.45 | 0.45 |
| chloride | catalyst | | | | | |
| Micronized wax | gloss reducer | 3 | 3 | 3 | 3 | 3 |
| Glass microbeads, | spherical filler | 8 | 0 | 0 | 8 | 8 |
| SG3000E | and gloss | | | | | |
| | reducer | | | | | |
| Glass microbeads, | spherical filler | 0 | 8 | 8 | 0 | 0 |
| SG5000E | and gloss | | | | | |
| | reducer | | | | | |
| Precipitated silica | spherical filler | 12 | 12 | 12 | 12 | 12 |
| | and gloss | | | | | |
| | reducer | | | | | |
| Castor oil derivative | viscosity | 0 | 0 | 0 | 0 | 1 |
| | modifier | | | | | |

The powder formulations had an average particle size of about 30 microns to about 35 microns as measured according to ASTM E2651. Each of the powder formulations was cured with heat (300° F.) to form a cured coating. Each of the coatings showed good methyl ethyl ketone (MEK) resistance. The coatings exhibited the following properties as shown in Table 5.

TABLE 5
Properties of coatings prepared from example powder formulations

| | Powder Formulation Example | | | | |
|---|---|---|---|---|---|
| | 5-1 | 5-2 | 5-3 | 5-4 | 5-5 |
| Gloss on MDF | 26.5 | 31.6 | 35.1 | 25.9 | 26.8 |
| Gel Time at 350° F. | 50 | 45 | 50 | 51 | 46 |
| (sec) | | | | | |
| Pill Flow | 40 mm | 50 mm | 48 mm | 50 mm | 45 mm |
| (174° C. with 0.75 g) | | | | | |

### Example 6: Powder Formulations

Specific examples of powder formulations (Examples 6-1 and 6-2) for application to a heat-sensitive substrate (e.g., MDF, particle board) prepared according to Example 1 are provided in Table 6.

TABLE 6
Powder formulations

| | | Ex. 6-1 | Ex. 6-2 |
|---|---|---|---|
| Component | Use | Wt % | Wt % |
| Acid functional polyester | polyester resin | 52.6 | 52.6 |
| resin (acid value >30) | | | |
| Triglycidyl isocyanurate (TGIC) | curing agent | 3.9 | 3.9 |
| Mixture of acrylic | flow modifier | 1.0 | 1.0 |
| polymer and silica | | | |
| Modified wax | viscosity modifier | 1.0 | 1.0 |
| Carboxylic acid ester | antistatic agent and | 0.5 | 0.5 |
| | transfer efficiency | | |
| | additive | | |
| Amide modified phenolated | degassing agent | 0.5 | 0.5 |
| urea surfactant | | | |
| Titanium dioxide | pigment | 17 | 17 |
| Benzyltriethylammonium | phase-transfer | 0.45 | 0.45 |
| chloride | catalyst | | |
| Precipitated silica | spherical filler | 0 | 15 |
| | and gloss reducer | | |
| Sodium aluminum silicate | Filler | 23.05 | 8.05 |

Each of the powder formulations was cured with heat to form a cured coating. The coatings exhibited the following properties as shown in Table 7.

TABLE 7
Properties of coatings prepared from example powder formulations

| | Powder Formulation Example | | | | | |
|---|---|---|---|---|---|---|
| | 6-1 | | 6-2 | | Test Method | Additional Details |
| Gel Time at 300° F. | 100-150 | | 100-150 | | ASTM D4217 | Sample weight 0.65 g |
| (sec) | | | | | | |
| Gel Time at 350° F. | 35-38 | | 35-41 | | ASTM D4217 | Sample weight 0.65 g |
| (sec) | | | | | | |
| Gel Time at 400° F. | 11-15 | | 11-15 | | | Sample weight 0.65g |
| Pill Flow (340° F.) | 45-50 | mm | 50-55 | mm | ASTM D4242 | Modified sample |
| | | | | | | weight 0.35 g |
| Film Thickness on | 3.0-5.0 | | 3.0-5.0 | | ASTM D6132 | |
| MDF | | | | | | |
| Gloss on MDF | 25-35 | | 25-35 | | ASTM D523 | |
| Pencil Hardness on | 2H | | 2H | | ASTM D3362 | |
| MDF | | | | | | |
| Abrasion Resistance | 33 | mg | 28 | mg | ASTM D4060 | CS-17 Wheels, 1000 |

| | | | | |
|---|---|---|---|---|
| (loss of weight) | | | | g weight, 1000 |
| | | | | rotations |
| PCI Smoothness on | 6-7 | 6-7 | PCI | |
| MDF | | | | |
| Cross-Hatch Adhesion | 5B | 5B | ASTM D3359 | |
| on MDF | | | | |
| Impact Resistance on | 80/60 | 80/60 | ASTM D2794 | |
| R-35 steel | | | | |
| Heat Resistance Test | No cracks; | No cracks; | ANSI/KCMA | |
| | no blisters | no blisters | A161.1-2012 | |
| Cold Resistance Test | No cracks; | No cracks; | ANSI/KCMA | |
| | no blisters | no blisters | A161.1-2012 | |
| Water Resistance Test | No swelling; | No swelling; | ANSI/KCMA | |
| | no delamination | no delamination | A161.1-2012 | |
| Detergent Resistant | No swelling; | No swelling; | ANSI/KCMA | |
| Test | no delamination | no delamination | A161.1-2012 | |
| House Hold | No stains; | No stains; | ANSI/KCMA | Vinegar, Lemon |
| Chemicals | no discoloration | no discoloration | A161.1-2012 | Juice, Grape Juice, |
| | | | | Ketchup, Coffee, |
| | | | | Olive Oil, 100% |
| | | | | Alcohol for 24 hrs |
| Hinge Hold Test | No Swelling, | No Swelling, | | |
| | No Cracks, | No Cracks, | | |
| | no cracks | no cracks | | |
| | around the | around the | | |
| | hinge hole, | hinge hole, | | |
| | No cracks | No cracks | | |
| | along the | along the | | |
| | sides | sides | | |
| MEK Cure Test | 50 drs - no | 50 drs - no | ASTM D5402 | |
| | stain | stain | | |

### Example 7: Powder Formulations

A specific example of a powder formulation prepared according to Example 1 for application to a heat-sensitive substrate (e.g., MDF) is provided in Table 8.

TABLE 8
Powder formulation

| Component | Use | Wt % |
|---|---|---|
| Acid functional saturated | Pre-catalyzed polyester | 37.7 |
| polyester resin with | resin | |
| dispersed catalyst | | |
| Functional epoxy | gloss reducer, curing | 37.7 |
| | agent | |
| Mixture of acrylic | flow modifier | 1.5 |
| polymer and silica | | |
| Carboxylic acid ester | antistatic agent | 0.3 |
| Amide modified phenolated | degassing agent | 0.8 |
| urea surfactant | | |
| Titanium dioxide | pigment | 20.9 |
| Barium titanate | transfer efficiency | 0.7 |
| | additive | |
| Phenolic antioxidant | antioxidant | 0.3 |
| Total (wt %) | | 100 |

EEW refers to epoxy equivalent weight. The color of the formulation was matte beige. The powder formulation had an average particle size of about 35.0 microns according to ASTM E2651. The powder formulation was cured with heat (275° F.) to form a cured coating. The formulation had a gel time at 350° F. of about 42 seconds.

The coating had a smooth appearance, showed good methyl ethyl ketone (MEK) resistance, and had a cross-hatch adhesion score of 5B. The coating had a gloss of about 17.0.

### Example 8: Powder Formulations

An example of a powder formulation prepared according to Example 1 for application to a heat-sensitive substrate is provided in Table 9.

TABLE 9
Powder formulation

| | | Range |
|---|---|---|
| Component | Use | (wt %) |
| Acid functional saturated | polyester resin | 40-87 |
| polyester resin | | |
| Triglycidyl isocyanurate (TGIC) | curing agent | 5.0-9.7 |
| Mixture of acrylic | flow modifier | 0.1-2.0 |
| polymer and silica | | |
| Carboxylic acid ester | antistatic agent and | 0.0-2.5 |
| | transfer efficiency | |
| | additive | |
| Amide modified phenolated | degassing agent | 0.0-2.0 |
| urea surfactant | | |
| Blend of high molecular | gloss reducer | 0.0-3.0 |
| weight | | |
| polytetrafluoroethylene | | |
| and synthetic wax | | |
| Benzyltriethylammonium | phase-transfer catalyst | 0.05-6.0 |
| chloride | | |
| Colorants | pigment | 0.0-35.0 |
| Inorganic fillers | filler | 0.0-50.0 |
| PTFE additive | texture additive | 0.1-0.3 |
| Total (wt %) | | 100 |

The powder formulation had an average particle size of about 25-50. The powder formulation was cured with heat (235-275° F.) for 10-20 minutes to form a cured coating. The formulation had a gel time at 400° F. of about 14-25 seconds. The formulation had a gel time at 300° F. of about 35-120 seconds. The coating had a pill flow (174° C.) of about 13 mm to about 75 mm.

The coating had a smooth appearance, showed good methyl ethyl ketone (MEK) resistance, and had a cross-hatch adhesion score of 5B.

### Example 9: Powder Formulation

Specific examples of powder formulations (Examples 9-1, 9-2, 9-3, 9-4, 9-5, and 9-6) for application to a heat-sensitive substrate prepared according to Example 1 are provided in Table 10.

TABLE 10
Powder formulations

| | | Ex. | Ex. | Ex. | Ex. | Ex. | Ex. |
|---|---|---|---|---|---|---|---|
| | | 9-1 | 9-2 | 9-3 | 9-4 | 9-5 | 9-6 |
| Component | Use | Wt % | Wt % | Wt % | Wt % | Wt % | Wt % |
| Acid functional polyester | polyester resin | 67.5 | 67.5 | 67.5 | 67.5 | 67.5 | 67.5 |
| resin | | | | | | | |
| Triglycidyl isocyanurate | curing agent | 7.5 | 7.5 | 7.5 | 7.5 | 7.5 | 7.5 |
| (TGIC) | | | | | | | |
| Benzyltriethylammonium | phase-transfer | 0.4 | 0.4 | 0.4 | 0.4 | 0.4 | 0.4 |
| chloride | catalyst | | | | | | |
| Carboxylic acid ester | antistatic agent | 1.0 | 1.0 | 1.0 | 1.0 | 1.0 | 1.0 |
| | and transfer | | | | | | |
| | efficiency | | | | | | |
| | additive | | | | | | |
| Blend of | Gloss reducer/ | 1.4 | 1.0 | 1.0 | 1.0 | 1.0 | 0.8 |
| polytetrafluoroethylene | matting agent, | | | | | | |
| and polyethylene | abrasion and | | | | | | |
| | scratch | | | | | | |
| | resistant | | | | | | |
| | additive, | | | | | | |
| | texture | | | | | | |
| | additive | | | | | | |
| Barium sulfate | filler, hardness | 4.25 | 4.0 | 4.2 | 4.32 | 4.05 | 4.55 |
| | enhancer, | | | | | | |
| | surface | | | | | | |
| | smoothing | | | | | | |
| | additive | | | | | | |
| Titanium dioxide | Pigment | 16.0 | 16.0 | 16.0 | 16.0 | 16.0 | 16.0 |
| Iron oxide yellow | Pigment | 1.4 | 1.4 | 1.4 | 1.5 | 1.73 | 1.5 |
| colorant | | | | | | | |
| Iron oxide red colorant | Pigment | 0.1 | 0.6 | 0.4 | .18 | .23 | .2 |
| Iron oxide black colorant | Pigment | 0.45 | 0.6 | 0.6 | 0.6 | 0.59 | 0.55 |

Each of the powder formulations was cured with heat to form a cured coating. The coatings exhibited the following properties as shown in Table 11.

TABLE 11
Properties of coatings prepared from
example 9-1 powder formulation

| Powder Formulation Example | Ex. 9-1 | |
|---|---|---|
| Particle Size | 32.7 | |
| Gel Time at 400° F. | 16 | sec |
| DFT | 2.8-3.3 | mil |

| | |
|---|---|
| 20 Gloss | 2.2 |
| 60 Gloss | 15 |
| PCI Smoothness | 1 |

DFT was measured using a film using a film thickness gauge using ASTM D6132 or D7091. Gloss was measured at 20° and 60° angles using a gloss meter as per ASTM D523. PCI Smoothness was determined by evaluative comparison of the coating's smoothness against standardized panels provided by Powder Coating Institute (PCI).

### Example 10: Powder Formulations

Specific examples of powder formulations (Examples 10-1, 10-2, 10-3, 10-4, 10-5, and 10-6) prepared according to Example 1 are provided in Table 12.

TABLE 12
Powder formulations

| | | Ex. | Ex. | Ex. | Ex. | Ex. | Ex. |
|---|---|---|---|---|---|---|---|
| | | 10-1 | 10-2 | 10-3 | 10-4 | 10-5 | 10-6 |
| Component | Use | Wt % | Wt % | Wt % | Wt % | Wt % | Wt % |
| Acid functional polyester | Polyester | 64.8 | 64.8 | 64.8 | 64.8 | 64.8 | 64.8 |
| resin | resin | | | | | | |
| Triglycidyl isocyanurate | Curing agent | 7.2 | 7.2 | 7.2 | 7.2 | 7.2 | 7.2 |
| (TGIC) | | | | | | | |
| Blend of | gloss reducer, | 3.5 | 2.0 | 1.5 | 1.5 | 1.0 | 1.0 |
| polytetrafluoroethylene | smoothing | | | | | | |
| and synthetic wax | agent, scratch | | | | | | |
| | resistance, | | | | | | |
| | and lubricity | | | | | | |
| | agent | | | | | | |
| Carboxylic acid ester | Antistatic | 1.5 | 1.5 | 1.5 | 1.5 | 1.5 | 1.5 |
| | agent and | | | | | | |
| | transfer | | | | | | |
| | efficiency | | | | | | |
| | additive | | | | | | |
| Benzyltriethylammonium | Phase- | 0.4 | 0.4 | 0.4 | 0.4 | 0.4 | 0.4 |
| chloride | transfer | | | | | | |
| | catalyst | | | | | | |
| Barium sulfate | Filler | 0.5 | 0.5 | — | 1.0 | — | — |
| Synthetic polymer | Texture | — | — | 1.0 | — | 1.0 | 1.5 |
| | additive | | | | | | |
| Titanium dioxide | Pigment | 22.0 | 22.0 | 22.0 | 22.0 | 22.0 | 22.0 |
| Iron oxide yellow | Pigment | 0.01 | 0.03 | 0.03 | 0.03 | 0.03 | 0.03 |
| colorant | | | | | | | |
| Iron oxide black colorant | Pigment | 0.01 | 0.01 | 0.01 | 0.01 | 0.01 | 0.01 |

Each of the powder formulations was cured with heat to form a cured coating. The coatings exhibited the following properties as shown in Table 13.

TABLE 13
Properties of coatings prepared from example powder formulations

| Powder Formulation | Ex. | | Ex. | | Ex. | | Ex. | | Ex. | | Ex. | |
|---|---|---|---|---|---|---|---|---|---|---|---|---|
| Example | 10-1 | | 10-2 | | 10-3 | | 10-4 | | 10-5 | | 10-6 | |
| Particle Size | 49.6 | | | | | | | | | | | |
| MEK 50 2x | Pass-5 | | Pass-5 | | Pass-5 | | Pass-4 | | Pass-4 | | Pass-4 | |
| Cross Hatch Adhesion | 5B (0%) | | 5B (0%) | | 5B (0%) | | 5B (0%) | | 5B (0%) | | 5B (0%) | |
| Pill Flow at 174° C. | 13 | mm | 14 | mm | 15 | mm | 14 | mm | 14 | mm | 14 | mm |
| Gel Time at 205° C. | 11 | sec | 18 | sec | 16 | sec | 17 | sec | 16 | sec | 17 | sec |
| DFT | 4.4-5.0 | mil | 3.1-3.7 | mil | 3.3-4.0 | mil | 2.5-3.3 | mil | 3.4-3.9 | mil | 3.2-4.0 | mil |

| | | | | | | |
|---|---|---|---|---|---|---|
| 60 Gloss | 1.2 | 4.9 | 4.5 | 11.4 | 10.3 | 10.0 |

### Example 11: Powder Formulation

A specific example of a powder formulation prepared according to Example 1 for application to a heat-sensitive substrate is provided in Table 14.

TABLE 14
Powder formulation

| Component | Use | Wt % |
|---|---|---|
| Acid functional polyester resin | Polyester resin | 65.8 |
| Triglycidyl isocyanurate (TGIC) | Curing agent | 7.3 |
| Blend of polytetrafluoroethylene | Gloss reducer, | 1.5 |
| and synthetic wax | smoothing agent, | |
| | scratch resistance | |
| | and lubricity agent | |
| Carboxylic acid ester | Antistatic agent and | 1.5 |
| | transfer efficiency | |
| | additive | |
| Benzyltriethylammonium | Phase-transfer | 0.4 |
| chloride | catalyst | |
| Barium sulfate | Filler | 1.02 |
| Titanium dioxide | Pigment | 22.4 |
| Iron oxide yellow colorant | Pigment | 0.03 |
| Iron oxide black colorant | Pigment | 0.01 |

### Example 12: Powder Formulation

A specific example of a powder formulation prepared according to Example 1 is provided in Table 15.

TABLE 15
Non-limiting example of a powder formulation

| Component | Use | Wt % |
|---|---|---|
| Acid functional polyester resin | Polyester resin | 67.5 |
| Triglycidyl isocyanurate (TGIC) | Curing agent | 7.5 |
| Benzyltriethylammonium | phase-transfer | 0.4 |
| chloride | catalyst | |
| Carboxylic acid ester | antistatic agent and | 1.0 |
| | transfer efficiency | |
| | additive | |
| Barium sulfate | Filler | 4.55 |
| Titanium dioxide | Pigment | 16.0 |
| Iron oxide yellow colorant | Pigment | 1.5 |
| Iron oxide red colorant | Pigment | 0.2 |
| Iron oxide black colorant | Pigment | 0.55 |
| Blend of polyethylene and | Gloss reducer/ | 0.8 |
| polytetrafluorethylene | matting agent, | |
| | abrasion and scratch | |
| | resistant additive, | |
| | texture additive | |

### Example 13: Method of Applying Powder Formulation to a Heat Sensitive Substrate

A thermoset powder coating as described herein can be applied to a heat sensitive substrate such as MDF and HDF according to the following example procedure.

The formulation was applied to Medium Density Fiber Board (MDF) with moisture in the range of 5-10%. The MDF was preheated to the board surface temperature of 140° F. to 170° F. for about 40-60 seconds (preheat times can vary) before powder application. The powder formulation was applied with a corona electrostatic powder spray gun at between 20 kV-90 kV. The voltage, charge, and flow rate was adjusted as appropriate.

The powder formulation was cured in an electric or gas catalytic infrared oven. A combination of any of these ovens is also suitable. The cure onset was 3 minutes at 130° C. (266° F.) Board Surface Temperature (MDF). The temperature profile and/or ramp settings may be adjusted to achieve the desired coating.

In some examples, sanding of the substrate was found to improve surface smoothness prior to application and cure. For example, with sand paper grit of 250 # and above. Parts can be recoated if defects are visible such as outgassing or pinholes, after sanding with a fine grit sandpaper of 220 # or higher.

### Example 14: Pill Flow of Example Powder Formulations

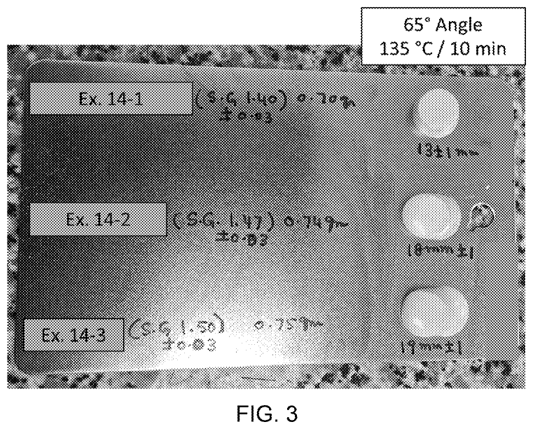

The flow of example powder formulations was measured at 135° C. using a 65° pill plate for a time of 10 minutes. FIG. 3 shows flow measurements for three example powder formulations (14-1, 14-2, and 14-3). Example 14-1 had a flow of 13±1 mm; specific gravity (S.G.) of 1.40±0.03. Example 14-2 had a flow of 18±1 mm; specific gravity of 1.47±0.03. Example 14-3 had a flow of 19±1 mm; specific gravity of 1.50±0.03.

### Other Embodiments

Exemplary embodiments are provided below.

Embodiment 1 is a powder formulation for a heat sensitive substrate, comprising:
an acid functional polyester resin;
a curing agent;
a degassing agent;
a catalyst;
a flow modifier;
a transfer efficiency additive;
an antistatic agent; and
one or more of the following: a spherical filler, an amorphous metal silicate, a crystalline resin, a thermoplastic additive, an adhesion promoter, a co-crosslinker, and a gloss reducer.

Embodiment 2 is the powder formulation of Embodiment 1, comprising:
about 30 wt % to about 90 wt % of the acid functional polyester resin;
about 3 wt % to about 10 wt % of the curing agent;
about 0.1 wt % to about 5 wt % of the degassing agent;
about 0.1 wt % to about 6 wt % of the catalyst;
about 0.1 wt % to about 5 wt % of the flow modifier;
about 0.1 wt % to about 5 wt % of the transfer efficiency additive; and
about 0.1 wt % to about 5 wt % of the antistatic agent.

Embodiment 3 is the powder formulation of Embodiment 1 or 2, wherein the formulation further comprises one or more of a viscosity modifier and an antimicrobial agent.

Embodiment 4 is the powder formulation of any one of Embodiments 1 to 3, wherein the antistatic agent is the transfer efficiency additive.

Embodiment 5 is the powder formulation of any one of Embodiments 1-4, wherein the powder formulation is formulated to provide a thermoset powder coating.

Embodiment 6 is the powder formulation of Embodiment 5, wherein the coating has one or more of the following characteristics:
improved flexibility under humid conditions;
improved inter-coat adhesion;
improved water permeability;
improved exterior weathering;
improved uniform integrity;
improved outgassing during cure; and/or improved heat distribution.

Embodiment 7 is a powder formulation for a heat sensitive substrate, comprising:
an acid functional polyester resin;
a curing agent;
a degassing agent;
a phase-transfer catalyst;
a flow modifier;
a transfer efficiency additive;
an antistatic agent; and
optionally one or more of the following: a spherical filler, an amorphous metal silicate, a crystalline resin, a thermoplastic additive, an adhesion promoter, a co-crosslinker, a gloss reducer, a viscosity modifier, and an antimicrobial agent;
wherein the formulation has one or more of the following characteristics:
improved flexibility under humid conditions;
improved inter-coat adhesion;
improved water permeability;
improved exterior weathering;
improved uniform integrity;
improved outgassing during cure; and/or
improved heat distribution.

Embodiment 8 is the powder formulation of any one of Embodiments 1-7, wherein the heat sensitive substrate comprises a non-metal substrate.

Embodiment 9 is the powder formulation of any one of Embodiments 1-8, wherein the heat sensitive substrate comprises an oriented strand board, fiber-cement siding, engineered cement board, wood, fiberglass board, particle board, medium-density fiberboard, or high-density fiberboard.

Embodiment 10 is the powder formulation of any one of Embodiments 1-9, wherein the acid functional polyester resin is a polyester resin with an acid value of 30-70.

Embodiment 11 is the powder formulation of any one of Embodiments 1-10, wherein the acid functional polyester resin is an isophthalic acid based polyester resin, a terephthalic acid based polyester resin, or a polyester resin with carboxylic acid groups.

Embodiment 12 is the powder formulation of any one of Embodiments 1-11, wherein the curing agent comprises a polyepoxide, an isocyanate, a glycidyl ester, a hydroxyalkylamide, or a combination thereof.

Embodiment 13 is the powder formulation of Embodiment 12, wherein the curing agent comprises triglycidyl isocyanurate, tris(2,3-epoxypropyl) isocyanurate, glycidyl methacrylate, triglycidyl trimellitate, diglycidyl terephthalate, β-hydroxyalkylamide, or a combination thereof.

Embodiment 14 is the powder formulation of any one of Embodiments 1-13, wherein the degassing agent comprises benzoin, benzoin coated polyamide, polyamide, polyethylene, a modified or derivative form thereof, or a combination thereof.

Embodiment 15 is the powder formulation of any one of Embodiments 1-14, wherein the one or more spherical fillers comprises a particle size from about 0.1 to 60 microns.

Embodiment 16 is the powder formulation of any one of Embodiments 1-15, wherein the amorphous metal silicate comprises pumice.

Embodiment 17 is the powder formulation of any one of Embodiments 1-16, wherein the amorphous metal silicate comprises a particle size from about 0.1 to 20 microns.

Embodiment 18 is the powder formulation of any one of Embodiments 1-17, wherein the phase-transfer catalyst comprises an ammonium salt or a phosphonium salt.

Embodiment 19 is the powder formulation of Embodiment 18, wherein the ammonium salt comprises N+(RN1)4X—, and wherein each RN1 is, independently, hydrogen (H) or an optionally substituted C1-18 hydrocarbyl group (e.g., alkyl, haloalkyl, aryl, alkaryl, aralkyl) and X is an anion.

Embodiment 20 is the powder formulation of Embodiment 18 or 19, wherein the ammonium salt comprises a tetraalkylammonium halide (e.g., benzyltriethylammonium chloride, benzyltrimethylammonium chloride, tetrabutylammonium bromide, tetrabutylammonium chloride, tetrabutylammonium iodide, tetradecylammonium bromide, tetradecylammonium chloride, tetradecylammonium iodide, butyl triethyl ammonium bromide, butyl triethyl ammonium chloride, or a combination thereof).

Embodiment 21 is the powder formulation of any one of Embodiments 1-20, wherein the flow modifier comprises an acrylic polymer.

Embodiment 22 is the powder formulation of any one of Embodiments 1-21, wherein the flow modifier further comprises amorphous precipitated silica.

Embodiment 23 is the powder formulation of any one of Embodiments 1-22, wherein the transfer efficiency additive comprises barium titanate, zirconium titanate, strontium titanate, barium strontium titanate, potassium niobate, sodium niobate, or a combination thereof.

Embodiment 24 is the powder formulation of any one of Embodiments 1-23, wherein the antistatic agent comprises an isocyanate (e.g., a polyisocyanate, an isocyanate adduct, an aliphatic polyisocyanate, a cycloaliphatic polyisocyanate), a glycidyl ester (e.g., glycidyl methacrylate, triglycidyl trimellitate, diglycidyl terephthalate), a hydroxyalkylamide (e.g., β-hydroxyalkylamide), or a combination thereof.

Embodiment 25 is the powder formulation of any one of Embodiments 1-24, wherein the antistatic agent acts as a co-crosslinker.

Embodiment 26 is the powder formulation of any one of Embodiments 1-25, comprising a combination of a crystalline resin, a thermoplastic additive, a viscosity modifier, an adhesion promoter, and one or more antimicrobial agents.

Embodiment 27 is the powder formulation of any one of Embodiments 1-26, comprising a combination of a crystalline resin, a thermoplastic additive, a gloss reducer, and one or more antimicrobial agents.

Embodiment 28 is the powder formulation of any one of Embodiments 1-27, comprising a thermoplastic additive.

Embodiment 29 is the powder formulation of any one of Embodiments 1-28, comprising a combination of an adhesion promoter and a gloss reducer.

Embodiment 30 is the powder formulation of any one of Embodiments 1-29, further comprising a pigment (e.g., a non-conductive pigment).

Embodiment 31 is the powder formulation of Embodiment 30, wherein the pigment comprises an organic pigment (e.g., carbon black), an inorganic pigment (e.g., titanium dioxide), or a combination thereof.

Embodiment 32 is the powder formulation of any one of Embodiments 1-31, wherein the acid functional polyester resin is present in a total amount of about 40 wt % to about 65 wt % of the formulation.

Embodiment 33 is the powder formulation of any one of Embodiments 1-32, wherein the acid functional polyester resin is present in a total amount of about 60 wt % to about 62 wt % of the formulation.

Embodiment 34 is the powder formulation of any one of Embodiments 1-33, wherein the acid functional polyester resin is present in a total amount of 63 wt % of the formulation.

Embodiment 35 is the powder formulation of any one of Embodiments 1-32, wherein the acid functional polyester resin is present in a total amount of 64 wt % of the formulation.

Embodiment 36 is the powder formulation of any one of Embodiments 1-33, wherein the acid functional polyester resin is present in a total amount of 60 wt % of the formulation.

Embodiment 37 is the powder formulation of any one of Embodiments 1-36, wherein the curing agent is present in a total amount of about 4 wt % to about 10 wt % of the formulation.

Embodiment 38 is the powder formulation of any one of Embodiments 1-36, wherein the curing agent is present in a total amount of about 5 wt % to about 7 wt % of the formulation.

Embodiment 39 is the powder formulation of any one of Embodiments 1-38, wherein the degassing agent is present in a total amount of about 0.05 wt % to about 5 wt % of the formulation.

Embodiment 40 is the powder formulation of any one of Embodiments 1-39, wherein the one or more spherical fillers are present in a total amount of about 1 wt % to about 30 wt % of the formulation.

Embodiment 41 is the powder formulation of any one of Embodiments 1-40, wherein the one or more spherical fillers are present in a total amount of about 4 wt % to about 18 wt % of the formulation.

Embodiment 42 is the powder formulation of any one of Embodiments 1-41, wherein the one or more spherical fillers are present in a total amount of 4 wt % of the formulation.

Embodiment 43 is the powder formulation of any one of Embodiments 1-41, wherein the one or more spherical fillers are present in a total amount of 5 wt % of the formulation.

Embodiment 44 is the powder formulation of any one of Embodiments 1-41, wherein the one or more spherical fillers are present in a total amount of 14 wt % of the formulation.

Embodiment 45 is the powder formulation of any one of Embodiments 1-44, wherein the amorphous metal silicate is present in a total amount of about 1 wt % to about 30 wt % of the formulation.

Embodiment 46 is the powder formulation of any one of Embodiments 1-45, wherein the amorphous metal silicate is present in a total amount of about 1 wt % to about 10 wt % of the formulation.

Embodiment 47 is the powder formulation of any one of Embodiments 1-46, wherein the amorphous metal silicate is present in a total amount of about 1 wt % to about 5 wt % of the formulation.

Embodiment 48 is the powder formulation of any one of Embodiments 1-41, wherein the one or more spherical fillers are present in a total amount of 2.5 wt % of the formulation.

Embodiment 49 is the powder formulation of any one of Embodiments 1-48, wherein the phase-transfer catalyst is present in a total amount of about 0.1 wt % to about 5 wt % of the formulation.

Embodiment 50 is the powder formulation of any one of Embodiments 1-49, wherein the phase-transfer catalyst is present in a total amount of about 0.2 wt % to about 2 wt % of the formulation.

Embodiment 51 is the powder formulation of any one of Embodiments 1-50, wherein the phase-transfer catalyst is present in a total amount of 0.45 wt % of the formulation.

Embodiment 52 is the powder formulation of any one of Embodiments 1-51, wherein the flow modifier is present in a total amount of about 0.1 wt % to about 5 wt % of the formulation.

Embodiment 53 is the powder formulation of any one of Embodiments 1-52, wherein the flow modifier is present in a total amount of about 0.2 wt % to about 2 wt % of the formulation.

Embodiment 54 is the powder formulation of any one of Embodiments 1-53, wherein the flow modifier is present in a total amount of about 0.8 wt % of the formulation.

Embodiment 55 is the powder formulation of any one of Embodiments 1-54, wherein the transfer efficiency additive is present in a total amount of about 0.1 wt % to about 5 wt % of the formulation.

Embodiment 56 is the powder formulation of any one of Embodiments 1-55, wherein the transfer efficiency additive is present in a total amount of about 0.2 wt % to about 2 wt % of the formulation.

Embodiment 57 is the powder formulation of any one of Embodiments 1-56, wherein the transfer efficiency additive is present in a total amount of about 0.75 wt % of the formulation.

Embodiment 58 is the powder formulation of any one of Embodiments 1-57, wherein the antistatic agent is present in a total amount of about 0.1 wt % to about 2 wt % of the formulation.

Embodiment 59 is the powder formulation of any one of Embodiments 1-58, wherein the antistatic agent is present in a total amount of about 0.5 wt % of the formulation.

Embodiment 60 is the powder formulation of any one of Embodiments 1-59, further comprising a pigment present in a total amount of about 10 wt % to about 30 wt % of the formulation.

Embodiment 61 is the powder formulation of any one of Embodiments 1-60, further comprising a pigment present in a total amount of about 12 wt % to about 25 wt % of the formulation.

Embodiment 62 is the powder formulation of any one of Embodiments 1-61, further comprising a pigment present in a total amount of about 15 wt % of the formulation.

Embodiment 63 is the powder formulation of any one of Embodiments 1-61, further comprising a pigment present in a total amount of about 18.5 wt % of the formulation.

Embodiment 64 is the powder formulation of any one of Embodiments 1-61, further comprising a pigment present in a total amount of about 20 wt % of the formulation.

Embodiment 65 is the powder formulation of any one of Embodiments 1-64, wherein the crystalline resin is present in a total amount of about 1 wt % to about 10 wt % of the formulation.

Embodiment 66 is the powder formulation of any one of Embodiments 1-65, wherein the thermoplastic additive is present in a total amount of about 0.5 wt % to about 5 wt % of the formulation.

Embodiment 67 is the powder formulation of any one of Embodiments 1-66, wherein the adhesion promoter is present in a total amount of about 0.1 wt % to about 5 wt % of the formulation.

Embodiment 68 is the powder formulation of any one of Embodiments 1-67, wherein the co-crosslinker is present in a total amount of about 0.1 wt % to about 5 wt % of the formulation.

Embodiment 69 is the powder formulation of any one of Embodiments 1-68, wherein the gloss reducer is present in a total amount of about 1 wt % to about 5 wt % of the formulation.

Embodiment 70 is the powder formulation of any one of Embodiments 1-69, wherein the viscosity modifier is present in a total amount of about 1 wt % to about 10 wt % of the formulation.

Embodiment 71 is the powder formulation of any one of Embodiments 1-70, wherein the one or more antimicrobial agents are present in a total amount of about 1 wt % to about 10 wt % of the formulation.

Embodiment 72 is a powder formulation for a heat sensitive substrate comprising:
about 40 wt % to about 65 wt % of an acid functional polyester resin (e.g., SP-6491);
about 4 wt % to about 10 wt % of a curing agent (e.g., triglycidyl isocyanurate (TGIC);
about 0.05 wt % to about 5 wt % of a degassing agent (e.g., benzoin);
about 1 wt % to about 20 wt % of one or more spherical fillers (e.g., Spheriglass 3000E and/or Spherilex DP-015);
about 1 wt % to about 30 wt % of an amorphous metal silicate (e.g., SafSil Pumice CT200, SafSil Pumice CT450, and/or SafSil Pumice CT550); about 0.1 wt % to about 5 wt % of a phase-transfer catalyst (e.g., tetraalkyl ammonium halide);
about 0.1 wt % to about 5 wt % of a flow modifier (e.g., an acrylic polymer);
about 0.1 wt % to about 5 wt % of a transfer efficiency additive (e.g., barium titanate); and
about 0.1 wt % to about 2 wt % of an antistatic agent (e.g., a hydroxyalkylamide).

Embodiment 73 is the powder formulation of Embodiment 72, further comprising a pigment, a crystalline resin, a thermoplastic additive, an adhesion promoter, a co-crosslinker a gloss reducer, a viscosity modifier, or an antimicrobial agent, or a combination thereof to provide 100 wt %.

Embodiment 74 is a method of applying a powder formulation for a heat sensitive substrate comprising:
pre-heating the heat sensitive substrate to a first temperature;
applying a powder formulation of any one of Embodiments 1-73 to the heat sensitive substrate to form a coat on at least a portion of a surface of the heat sensitive substrate; and
heating the heat sensitive substrate with the coat applied thereon to a second temperature, thereby forming a cured coating on at least a portion of the surface of the heat sensitive substrate.

Embodiment 75 is the method of Embodiment 74, wherein the heat sensitive substrate comprises a non-metal substrate.

Embodiment 76 is the method of Embodiment 74 or 75, wherein the heat sensitive substrate comprises an oriented strand board, fiber-cement siding, engineered cement board, wood, fiberglass board, particle board, medium-density fiberboard, or high-density fiberboard.

Embodiment 77 is the method of any one of Embodiments 74-76, wherein pre-heating the heat sensitive substrate comprises pre-heating the heat sensitive substrate to a first temperature of about 80° F. to about 360° F.

Embodiment 78 is the method of any one of Embodiments 74-77, wherein pre-heating the heat sensitive substrate comprises pre-heating the heat sensitive substrate to a first temperature of about 100° F. to about 300° F.

Embodiment 79 is the method of any one of Embodiments 74-78, wherein heating the heat sensitive substrate comprises heating the heat sensitive substrate to a second temperature of about 260° F. to about 300° F.

Embodiment 80 is the method of any one of Embodiments 74-49, wherein heating the heat sensitive substrate comprises heating the heat sensitive substrate to a second temperature of about 270° F. to about 290° F.

Embodiment 81 is the method of any one of Embodiments 74-80, wherein heating the heat sensitive substrate comprises heating the heat sensitive substrate for between about 1 and about 20 minutes.

Embodiment 82 is the method of any one of Embodiments 74-81, wherein heating the heat sensitive substrate comprises heating the heat sensitive substrate for between about 6 and about 18 minutes.

Embodiment 83 is a powder coated substrate comprising:
a heat sensitive substrate; and
a cured coat disposed on at least a portion of a surface of the heat sensitive substrate, wherein the cured coat comprises the powder formulation of any one of Embodiments 1-73 or a cured form thereof.

Embodiment 84 is the powder coated substrate of Embodiment 83, wherein the heat sensitive substrate comprises a moisture content from about 2% to 13%.

Embodiment 85 is the powder coated substrate of Embodiment 83 or 84, wherein the heat sensitive substrate comprises a non-metal substrate.

Embodiment 86 is the powder coated substrate of any one of Embodiments 83-85, wherein the heat sensitive substrate comprises an oriented strand board, fiber-cement siding, engineered cement board, wood, fiberglass board, particle board, medium-density fiberboard, or high-density fiberboard.

Embodiment 87 is the powder coated substrate of any one of Embodiments 83-86, wherein the cured coat has a surface smoothness on the PCI scale of at least 5.

It is to be understood that while the document has been described in conjunction with the detailed description thereof, the foregoing description is intended to illustrate and not limit the scope of the document. Other aspects, advantages, and modifications are within the scope of the following claims.

1. A powder formulation for a heat sensitive substrate, comprising:
about 30 wt % to about 90 wt % of an acid functional polyester resin;
about 3 wt % to about 10 wt % of a curing agent;
about 0.1 wt % to about 6 wt % of a catalyst;
about 0.1 wt % to about 5 wt % of a transfer efficiency additive;
about 0.1 wt % to about 5 wt % of an antistatic agent; and
one or both of the following: about 1 wt % to about 30 wt % of a spherical filler, and about 0.1 wt. % to about 40 wt. % of a gloss reducer.

2. The powder formulation of claim 1, further comprising a degassing agent.

3. The powder formulation of claim 1, wherein the degassing agent is present in a total amount of about 0.05 wt % to about 5 wt % of the formulation.

4. The powder formulation of claim 1, further comprising a flow modifier.

5. The powder formulation of claim 1, comprising a degassing agent and a flow modifier.

6. The powder formulation of claim 1, further comprising one or more of the following: an amorphous metal silicate, a crystalline resin, a thermoplastic additive, an adhesion promoter, and a co-crosslinker.

7. A powder formulation for a heat sensitive substrate, comprising:
about 30 wt % to about 90 wt % of an acid functional polyester resin;
about 3 wt % to about 10 wt % of a curing agent;
about 0.1 wt % to about 5 wt % of a degassing agent;
about 0.1 wt % to about 6 wt % of a catalyst;
about 0.1 wt % to about 5 wt % of a flow modifier;
about 0.1 wt % to about 5 wt % of a transfer efficiency additive;
about 0.1 wt % to about 5 wt % of an antistatic agent; and
one or more of the following: about 1 wt % to about 20 wt % of a spherical filler, about 1 wt % to about 30 wt % of an amorphous metal silicate, about 1 wt % to about 30 wt % of a crystalline resin, about 0.1 wt % to about 5 wt % of a thermoplastic additive, about 1 wt % to about 30 wt % of an adhesion promoter, about 0.1 wt % to about 5 wt % of a co-crosslinker, and about 0.1 wt % to about 40 wt % of a gloss reducer.

8. The powder formulation of claim 1, wherein the formulation further comprises one or both of a viscosity modifier and an antimicrobial agent.

9. The powder formulation of claim 1, wherein the powder formulation is formulated to provide a thermoset powder coating.

10. The powder formulation of claim 9, wherein the coating has one or more of the following characteristics:
a cross-hatch adhesion of 4B to 5B using ASTM D3359;
a gloss retention of at least 30% and a color difference ΔE of less than 5 units according to ASTM G154 Cycle 1;
a gel time of about 30 seconds to about 80 seconds at 350° F. using ASTM D4217; and
a flow of about 13 mm to about 60 mm at 275° F. using ASTM test method D4242; and
the coating is substantially free of visible defects selected from the group consisting of cracking, swelling, blistering, bubbling, surface irregularities, outgassing, and combinations thereof.

11. The powder formulation of claim 1, wherein the heat sensitive substrate comprises a non-metal substrate.

12. The powder formulation of claim 1, wherein the heat sensitive substrate comprises an oriented strand board, fiber-cement siding, engineered cement board, wood, fiberglass board, particle board, medium-density fiberboard, or high-density fiberboard.

13.-24. (canceled)

25. The powder formulation of claim 1, wherein the powder formulation comprises the spherical filler.

26. The powder formulation of claim 25, wherein the spherical filler comprises glass microbeads, silica, or a combination thereof.

27.-56. (canceled)

57. The powder formulation of claim 1, wherein the powder formulation comprises the gloss reducer.

58.-88. (canceled)

89. The powder formulation of claim 1, comprising:
about 30 wt % to about 90 wt % of an acid functional polyester resin;
about 3 wt % to about 10 wt % of a curing agent, wherein the curing agent comprises triglycidyl isocyanurate;
about 0.1 wt % to about 6 wt % of a phase transfer catalyst, wherein the catalyst comprises benzyltriethylammonium chloride;
about 0.1 wt % to about 5 wt % of a transfer efficiency additive, wherein the transfer efficiency additive comprises barium titanate, a carboxylic acid ester, or a combination thereof;
about 0.1 wt % to about 5 wt % of an antistatic agent, wherein the antistatic agent comprises a hydroxyalkylamide crosslinker, a carboxylic acid ester, or a combination thereof; and
one or both of the following: about 1 wt % to about 30 wt % of a spherical filler, and about 0.1 wt. % to about 40 wt. % of a gloss reducer;
wherein the spherical filler comprises glass microbeads, silica, or a combination thereof; and
the gloss reducer comprises micronized wax, a functionalized epoxy, a blend of polytetrafluoroethylene and polyethylene, a blend of polytetrafluoroethylene and synthetic wax, or a combination thereof.

90. A powder formulation for a heat sensitive substrate comprising:
about 40 wt % to about 65 wt % of an acid functional polyester resin;
about 4 wt % to about 10 wt % of a curing agent;
about 0.05 wt % to about 5 wt % of a degassing agent;
about 1 wt % to about 20 wt % of one or more spherical fillers;
about 1 wt % to about 30 wt % of an amorphous metal silicate;
about 0.1 wt % to about 5 wt % of a phase-transfer catalyst;
about 0.1 wt % to about 5 wt % of a flow modifier;
about 0.1 wt % to about 5 wt % of a transfer efficiency additive; and
about 0.1 wt % to about 2 wt % of an antistatic agent.

91. The powder formulation of claim 90, further comprising a pigment, a crystalline resin, a thermoplastic additive, an adhesion promoter, a co-crosslinker a gloss reducer, a viscosity modifier, or an antimicrobial agent, or a combination thereof to provide 100 wt %.

92. A method of applying a powder formulation to a heat sensitive substrate comprising:
pre-heating the heat sensitive substrate to a first temperature;
applying a powder formulation of claim 1 to the heat sensitive substrate to form a coat on at least a portion of a surface of the heat sensitive substrate; and
heating the heat sensitive substrate with the coat applied thereon to a second temperature, thereby forming a cured coating on at least a portion of the surface of the heat sensitive substrate.

93.-100. (canceled)

101. A powder coated substrate comprising:
a heat sensitive substrate; and
a cured coating disposed on at least a portion of a surface of the heat sensitive substrate, wherein the cured coating comprises the powder formulation of claim 1 or a cured form thereof.

102.-105. (canceled)
